(19) United States
(12) Patent Application Publication
(10) Pub. No.: US 2025/0335168 A1
(43) Pub. Date: Oct. 30, 2025

(54) COMPUTER-READABLE RECORDING MEDIUM STORING COMPILING PROGRAM AND COMPILING METHOD

(71) Applicant: Fujitsu Limited, Kawasaki-shi (JP)

(72) Inventor: Shigeru KIMURA, Hachiouji (JP)

(73) Assignee: Fujitsu Limited, Kawasaki-shi (JP)

(21) Appl. No.: 19/054,964

(22) Filed: Feb. 17, 2025

(30) Foreign Application Priority Data
Apr. 30, 2024 (JP) 2024-074146

(51) Int. Cl. G06F 8/41

(52) U.S. Cl. CPC G06F 8/443

(57) ABSTRACT

A recording medium stores a program causing a computer to execute a process including: detecting a target loop process that includes store and load commands subsequent to the store command; and changing the detected target loop process into a first loop process of executing the store command in advance for a first number of times among the number of iteration times of the target loop process, a second loop process of executing the store and load commands for a second number of times obtained by subtracting the first number of times from the number of iteration times after the first loop process, and a third loop process of executing the load command for the first number of times after the second loop process such that an access addresses of the store and load commands are not in the same access unit from a processor to a memory.

### CROSS-REFERENCE TO RELATED APPLICATION

This application is based upon and claims the benefit of priority of the prior Japanese Patent Application No. 2024-74146, filed on Apr. 30, 2024, the entire contents of which are incorporated herein by reference.

### FIELD

The embodiments discussed herein are related to a computer-readable recording medium storing a compiling program and a compiling method.

### BACKGROUND

In the related art, in a case of executing a program in a computer, an optimization method of a compiler related to an array or a loop is devised. For example, there are methods such as loop unrolling for speeding up a loop process, a software pipeline, loop merging, loop coupling, array merging for speeding up the array, and reducing the number of dimensions of the array.

Japanese Laid-open Patent Publication No. 2021-196637 is disclosed as related art.

### SUMMARY

According to an aspect of the embodiments, a non-transitory computer-readable recording medium stores a compiling program causing a computer to execute a process including: detecting a target loop process that includes a store command and a load command subsequent to the store command, from a program as an optimization target; and changing the detected target loop process into a first loop process of executing the store command in advance for a first number of times among the number of iteration times of the target loop process, a second loop process of executing the store command and the load command for a second number of times obtained by subtracting the first number of times from the number of iteration times after the first loop process, and a third loop process of executing the load command for the first number of times after the second loop process such that an access address of the store command and an access address of the load command are not in the same access unit from a processor to a memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a compiling method according to an embodiment;

FIG. 2 is an explanatory diagram illustrating a first program example;

FIG. 3 is an explanatory diagram illustrating a second program example;

FIG. 4 is a block diagram illustrating a hardware configuration example of an information processing apparatus;

FIG. 5 is a block diagram illustrating a functional configuration example of the information processing apparatus;

FIG. 6 is an explanatory diagram illustrating a relationship between store and load;

FIG. 7 is an explanatory diagram illustrating a program example after loop reconfiguration;

FIG. 8 is an explanatory diagram illustrating a relationship between commands in an initial loop;

FIG. 9A is an explanatory diagram (part 1) illustrating a relationship of commands in a kernel loop;

FIG. 9B is an explanatory diagram (part 2) illustrating the relationship between commands in the kernel loop;

FIG. 10 is an explanatory diagram illustrating a relationship between commands in an end loop;

FIG. 11 is a flowchart illustrating an example of a compiling process procedure of the information processing apparatus;

FIG. 12 is an explanatory diagram illustrating an example of a target program;

FIG. 13 is an explanatory diagram illustrating an example of storage contents of a DO loop management table;

FIG. 14A is an explanatory diagram (part 1) illustrating an example of storage contents of array definition information;

FIG. 14B is an explanatory diagram (part 2) illustrating the example of the storage contents of the array definition information;

FIG. 14C is an explanatory diagram (part 3) illustrating the example of the storage contents of the array definition information;

FIG. 15 is an explanatory diagram illustrating a loop division example;

FIG. 16 is an explanatory diagram illustrating an example of dividing a source code;

FIG. 17 is an explanatory diagram illustrating an example of an initial loop;

FIG. 18 is an explanatory diagram illustrating an example of the kernel loop;

FIG. 19 is an explanatory diagram illustrating an example of changing a subscript of an array;

FIG. 20 is an explanatory diagram illustrating an example of the end loop;

FIG. 21 is an explanatory diagram illustrating assembler unrolling of a kernel loop after a loop configuration change;

FIG. 22 is an explanatory diagram illustrating a program example including an ocl statement;

FIG. 23 is an explanatory diagram illustrating an operation example using profile information and the like;

FIG. 24 is a flowchart illustrating an example of a profile information acquisition process procedure of the information processing apparatus;

FIG. 25 is an explanatory diagram illustrating a specific example of the profile information;

FIG. 26 is a flowchart illustrating an example of an event information acquisition process procedure of the information processing apparatus;

FIG. 27 is an explanatory diagram illustrating a configuration example of a compiler;

FIG. 28 is a flowchart illustrating an example of a specific process procedure of a compiling process of the information processing apparatus;

FIG. 29 is a flowchart illustrating an example of a specific process procedure of a first target loop detection process;

FIG. 30 is a flowchart illustrating an example of a specific process procedure of a second target loop detection process; and

FIG. 31 is a flowchart illustrating an example of a specific process procedure of a loop configuration change process.

### DESCRIPTION OF EMBODIMENTS

As the related art, for example, there is an execution technique for an optimization process on an optimization target program having a loop including a vector store command and a vector load command of an array variable. In the optimization process, unrolling of the vector store command and the vector load command in the loop is performed by a first unroll number or a second unroll number which is one less than the first unroll number, and scheduling of moving a vector load command after a vector store command at a head among a plurality of vector load commands after the unrolling to a position before the vector store command at the head is performed. The first unroll number is a number obtained by dividing a vector length by an array size of the array variable and rounding up the remainder.

Meanwhile, in the related art, there is a problem that performance of the program may be degraded due to a store fetch interlock (SFI) that occurs between a preceding store command and a subsequent load command.

In one aspect, an object of the present disclosure is to reduce a decrease in performance due to SFI.

Hereinafter, embodiments of a compiling program and a compiling method according to the present disclosure will be described in detail with reference to the drawings.

### EMBODIMENTS

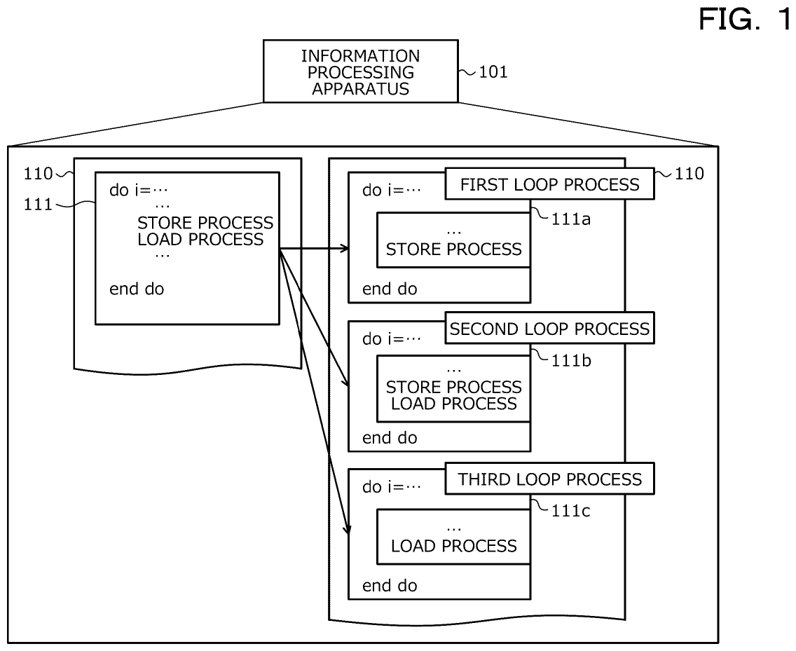

FIG. 1 is an explanatory diagram illustrating an example of a compiling method according to the embodiment. In FIG. 1, an information processing apparatus 101 is a computer that optimizes a program. The program as an optimization target is a source program described in a programming language. Examples of the programming language include C language, FORTRAN, Java, COBOL, shell, and the like.

The program as an optimization target includes a loop process including a store command and a load command subsequent to the store command. The store command is a command for performing a store process, and is, for example, a command for writing data for an array into a memory. The load process is a command for performing a load process, and is, for example, a command for reading the data for the array from the memory.

The information processing apparatus 101 is, for example, a server (general-purpose computer, supercomputer, or the like). The information processing apparatus 101 may be a personal computer (PC). The program as an optimization target may be, for example, an application for a high performance computer (HPC) or an application for business use.

In many cases, in a case where data read is performed (load command, fetch) after a memory rewrite store command in a processor, there is a logical contradiction in a case where the data read is executed before a preceding store command when a write address and a read address are the same. Therefore, the subsequent load command preferably waits for memory rewrite of the preceding store command.

On the other hand, in a case where the addresses are different, contradiction does not occur even in a case where a load command is executed earlier than a store command in a certain command execution group. Therefore, in recent processors, as an out-of-order mechanism, in a case where addresses of a preceding store command and a subsequent load command are different, the load command may be executed without waiting for the preceding store command. Therefore, a range of command scheduling is increased, and performance improvement may be expected.

In this manner, in a case where a memory rewrite address of the preceding store command is confirmed and the subsequent load command is input to a pipeline, when the write address and the read address for the memory coincide with each other, a logic is broken in a case where the load command overtakes the store command, and thus the load command may not be executed in advance.

Therefore, data is written in the memory, and then read from the same memory region. As hardware, read may not be started until write to the same memory region is completed, and the load command may not be executed parallel with the store command or may not be executed earlier than the store command. Therefore, in the related art, when SFI occurs, it is not possible to avoid a decrease in performance. The SFI is an internal delay during data transfer occurring by the hardware.

Therefore, some processors in recent years may be mounted with a store data forwarding function. The store data forwarding function is to alleviate a decrease in performance by bypassing preceding store data flowing in a store pipeline to a pipeline of a subsequent load command directly, instead of reading from a memory, in the subsequent load command.

Meanwhile, in the store data forwarding function, in a case where a store command and a load command to the same address are continued, a subsequent load command preferably waits for execution of a preceding store command, and thus the internal delay is only alleviated, and it is still difficult to avoid a decrease in performance.

As a method of avoiding this delay by software, it is conceivable to perform scheduling of inserting an arithmetic command or the like independent of the store command and the load command between the store command and the load command to conceal an internal delay occurring in the preceding store command and the subsequent load command. Meanwhile, in a case where there is no command that may be inserted between the store command and the load command, it is not possible to avoid a decrease in performance.

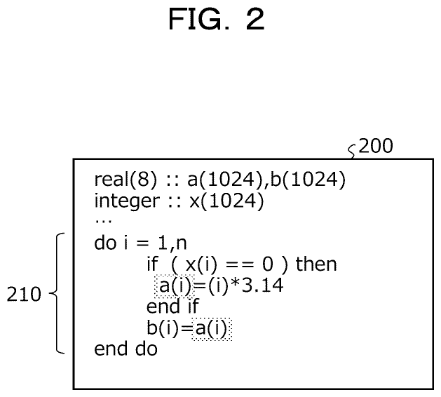

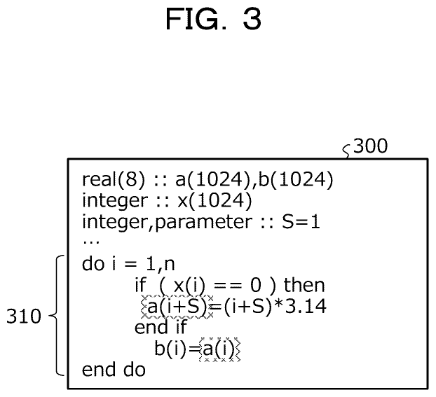

A program example in a case where a load command is unrolled immediately after a store command will be described with reference to FIGS. 2 and 3.

FIG. 2 is an explanatory diagram illustrating a first program example. In FIG. 2, a program 200 includes iteration (loop process 210) described in a do statement. In the program 200, a store command and a load command for a(i) are unrolled at a close interval in the process that is repeatedly executed. Since memory addresses to be accessed are the same, SFI occurs, and in the related art, even in a case where a store data forwarding function operates, a decrease in performance may not be avoided.

FIG. 3 is an explanatory diagram illustrating a second program example. In FIG. 3, a program 300 includes iteration (loop process 310) described in a do statement. S in the program 300 is an integer type variable, and corresponds to the number of elements of an array. In the example in FIG. 3, “S=1”. The example in FIG. 2 corresponds to a case of “S=0”.

Access addresses of a preceding store command and a subsequent load command are different (S=1). Meanwhile, SFI occurs even in a case where an address difference between the store command and the load command do not completely coincide with each other as long as the address difference is within the same cache line. For example, a cache line size of a processor is set to “256 bytes”.

In this case, data is transferred between a memory and a cache, in units of 256-byte cache line size, with a memory address at each 256-byte boundary. Here, since one element length is “8 bytes”, elements of an array a of 32 (=256/8) elements may be stored in one cache line size. Therefore, in a case where S is in a range of −31 to 31, there is a possibility that a(i+S) and a(i) are disposed at the address of the memory, which is the same cache line, and in this case, SFI occurs.

More specifically, the access addresses of the store command and the load command do not coincide with each other and the address difference is “S=1”, so that the access addresses are separated by one element size (8 bytes). Therefore, the store data forwarding function does not operate. In many cases, a unit for a memory write and read of data in a processor is a cache line size that is larger than a process unit of a store command and a load command (in the example in FIG. 3, 8 bytes).

Therefore, in the related art, there is a problem that even in a case where access addresses of a store command and a load command do not coincide with each other, writing and reading are performed on the same cache line, internal SFI occurs, and a significant decrease in performance occurs.

Therefore, in the present embodiment, a compiling method for reducing a decrease in performance caused by SFI occurring between a preceding store command and a subsequent load command will be described.

A process example of the information processing apparatus 101 will be described.

(1) The information processing apparatus 101 detects a target loop process from a program 110 as an optimization target. The target loop process includes a store command and a load command subsequent to the store command. The target loop process is, for example, a high-cost loop in which SFI may occur and a decrease in performance may occur.

For example, the information processing apparatus 101 may detect a loop process including a store command and a load command which cause SFI, as the target loop process by statically analyzing the program 110. The information processing apparatus 101 may detect a loop process designated by an instruction statement in the program 110 as the target loop process.

In the example in FIG. 1, a case is assumed in which a target loop process 111 is detected from the program 110.

(2) The information processing apparatus 101 changes the detected target loop process 111 to a first loop process 111a, a second loop process 111b, and a third loop process 111c. The first loop process 111a is a loop process of executing the store command in advance for the first number of times among the number of iteration times of the target loop process 111 such that an access address of the store command and an access address of the load command do not have the same access unit from a processor to a memory.

The access address of the store command is a write address for the memory. The access address of the load command is a read address for the memory. The access unit from the processor to the memory is a unit (block unit) in which reading and writing are performed with respect to the memory, and is, for example, a cache line.

The second loop process 111b is a loop process of executing the store command and the load command for the second number of times obtained by subtracting the first number of times from the number of iteration times of the target loop process 111 after the first loop process 111a. In the second loop process 111b, the access addresses of the store command and the load command are adjusted not to have the same access unit (for example, a cache line), and thus the store command and the load command are respectively executed without SFI occurring.

The third loop process 111c is a loop process of executing the load command for the first number of times after the second loop process 111b. In the third loop process 111c, only the remaining load commands are executed for the same first number of times as the first loop process 111a.

In this manner, with the information processing apparatus 101, it is possible to reduce a decrease in performance due to SFI that occurs between the preceding store command and the subsequent load command in the target loop process 111 for the program 110. For example, the information processing apparatus 101 may change a high-cost loop (target loop process 111) to three loop configurations (first loop process 111a, second loop process 111b, and third loop process 111c) that are logically equal.

The information processing apparatus 101 may provide an address difference between the store command and the load command which cause SFI, by executing the store command in advance in the first loop process 111a. Therefore, the information processing apparatus 101 may avoid consecutive region access in which the cache lines accessed by the preceding store command and the subsequent load command are the same.

With the information processing apparatus 101, in the second loop process 111b, the respective access addresses of the preceding store command and the subsequent load command are different cache lines, and thus SFI does not occur in the same loop process and it is possible to avoid a decrease in performance due to SFI. The information processing apparatus 101 may adjust the total processing amount by executing the remaining load command in the third loop process 111c.

The present compiling method is independent of a programming language. The present compiling method does not depend on the number of dimensions of an array, the number of rotations of a loop, and a multiplicity. In order to improve computing performance, the processor may be provided with a SIMD command for executing a plurality of pieces of data at once using the same arithmetic element. In a supercomputer desired to have high performance, a processor that operates on a server, or the like, it is effective to use a SIMD command. The present compiling method does not depend on the presence or absence of a single instruction multiple data (SIMD) command, and does not depend on a SIMD width length.

In the following description, as an example, the number of arrays may be described as “1” and “FORTRAN” may be described as a programming language. A case where a SIMD command is used will be described as an example. The SIMD command is a SIMD command having a SIMD width length of 8 in which 8 elements of 1 element of 8 bytes may be processed at the same time.

A cache line size may be described as “256 bytes”. Meanwhile, the cache line size is not limited to 256 bytes, and is set according to the processor. Although data of the array is described as an example of data to be handled, the present compiling method is not limited to the array, and may also be applied to a case in accordance with a grammar of language specifications that allow data to be referenced and set, such as a pointer variable.

### (Hardware Configuration Example of Information Processing Apparatus 101)

Next, a hardware configuration example of the information processing apparatus 101 will be described.

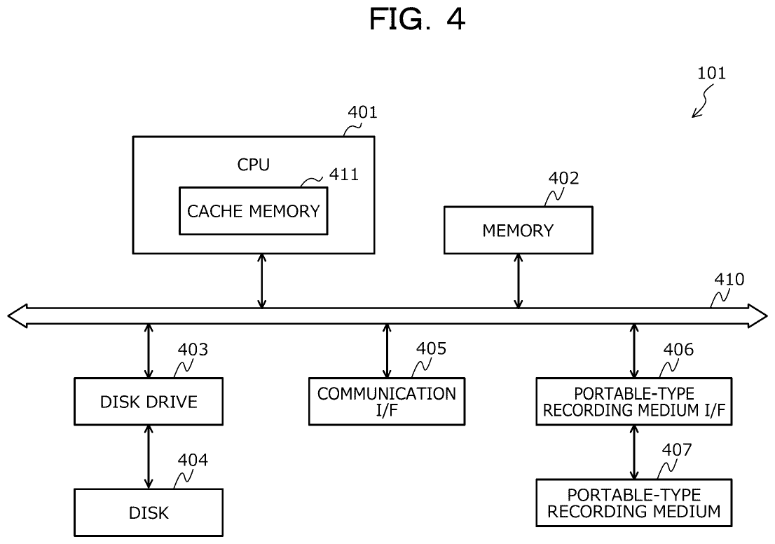

FIG. 4 is a block diagram illustrating a hardware configuration example of the information processing apparatus 101. In FIG. 4, the information processing apparatus 101 includes a central processing unit (CPU) 401, a memory 402, a disk drive 403, a disk 404, a communication interface (I/F) 405, a portable-type recording medium I/F 406, and a portable-type recording medium 407. The respective components are coupled to each other by a bus 410.

The CPU 401 is responsible for control of the overall information processing apparatus 101. The CPU 401 has a cache memory 411. The cache memory 411 is a storage device between the CPU 401 and the memory 402, and is used as a temporary storage destination of data. The CPU 401 may have a plurality of cores. Each core is an arithmetic circuit in the CPU 401.

The memory 402 includes, for example, a read-only memory (ROM), a random-access memory (RAM), and the like. A program stored in the memory 402 is loaded into the CPU 401, so that the CPU 401 executes a coded process.

The disk drive 403 controls a read and a write of data with respect to the disk 404 under the control of the CPU 401. The disk 404 stores data written under the control of the disk drive 403. Examples of the disk 404 include a magnetic disk, an optical disk, and the like.

The communication I/F 405 is coupled to a network through a communication line, and is coupled to an external computer via the network. The communication I/F 405 controls an interface between the network and an inside of the apparatus, and controls an input and an output of data from an external computer. The network is, for example, the Internet, a local area network (LAN), a wide area network (WAN), or the like. For example, a modem, a LAN adapter, or the like may be adopted as the communication I/F 405.

The portable-type recording medium I/F 406 controls a read and a write of data with respect to the portable-type recording medium 407 under the control of the CPU 401. The portable-type recording medium 407 stores data written under the control of the portable-type recording medium I/F 406. The portable-type recording medium 407 is, for example, a compact disc (CD)-ROM, a Digital Versatile Disk (DVD), a Universal Serial Bus (USB) memory, or the like.

The information processing apparatus 101 may include, for example, an input device and a display and the like, in addition to the components described above. The information processing apparatus 101 may not have, for example, the portable-type recording medium I/F 406 and the portable-type recording medium 407, among the components described above.

### (Functional Configuration Example of Information Processing Apparatus 101)

Next, a functional configuration example of the information processing apparatus 101 will be described.

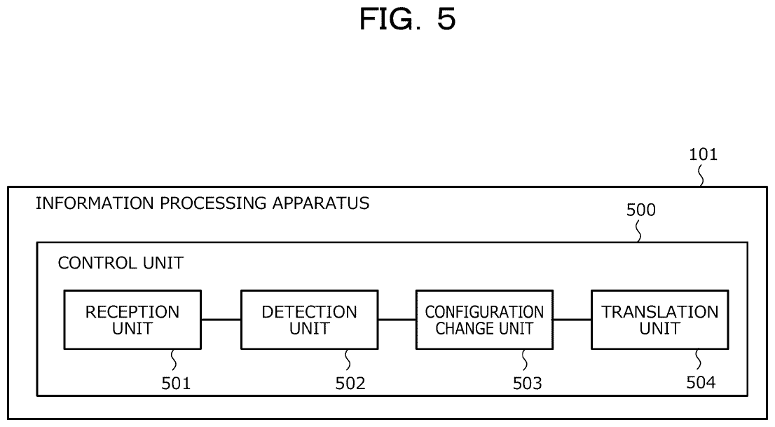

FIG. 5 is a block diagram illustrating a functional configuration example of the information processing apparatus 101. In FIG. 5, the information processing apparatus 101 includes a reception unit 501, a detection unit 502, a configuration change unit 503, and a translation unit 504. The reception unit 501 to the translation unit 504 function as a control unit 500, and for example, the CPU 401 executes a program stored in a storage device such as the memory 402, the disk 404, and the portable-type recording medium 407 illustrated in FIG. 4, or the communication I/F 405 to realize the function. A processing result of each functional unit is stored in, for example, a storage device such as the memory 402 and the disk 404. For example, each functional unit is realized by a compiler.

The reception unit 501 receives a program as an optimization target. The program as an optimization target includes a loop process including a preceding store command and a load command subsequent to the store command. The store command is, for example, a command to write data for an array into the memory 402. The load process is, for example, a command to read data for the array from the memory 402.

Data exchange between the CPU 401 and the memory 402 is performed, for example, via the cache memory 411 illustrated in FIG. 4. An access (write and read) from the CPU 401 to the memory 402 is performed in a predetermined access unit. The predetermined access unit is, for example, a cache line.

For example, the reception unit 501 may receive the program as an optimization target from an external computer via the communication I/F 405. The reception unit 501 may receive a program as an optimization target by an operation input of a user who uses an input device (not illustrated).

In the following description, the program as an optimization target may be denoted as a “target program”. A specific example of the target program will be described below with reference to FIG. 5. The access unit from the CPU 401 to the memory 402 is referred to as a “cache line”. Meanwhile, the access unit from the CPU 401 to the memory 402 may be, for example, a plurality of cache lines or may be an access unit different from the cache line.

The detection unit 502 detects a target loop process including a store command and a load command subsequent to the store command from the target program. For example, the detection unit 502 may detect a target loop process including a store command for the same variable and a load command subsequent to the store command. The variable is, for example, an array. Meanwhile, the variable may be one variable. The loop process as a detection target is, for example, an innermost loop.

For example, the detection unit 502 detects a loop process, which includes a store command for the same array and a load command subsequent to the store command and in which a value obtained by multiplying a difference in access address between the store command and the load command by a data size of a process unit is less than a cache line size, as the target loop process.

The process unit is a process uniting the store command and the load command, and is, for example, an element size of an array. The difference in access address between the store command and the load command is represented by, for example, the number of elements. The cache line size corresponds to an access unit from a processor (for example, the CPU 401) to a memory (for example, the memory 402).

Therefore, the detection unit 502 may automatically detect the loop process including the store command and the load command which cause SFI, as the target loop process. The SFI is an internal delay during data transfer occurring by the hardware. The SFI may occur, for example, in a case where the access addresses are the same in a preceding store command and a subsequent load command. The SFI may occur in a case where the access addresses of the preceding store command and the subsequent load command are close to each other, and thus the access addresses are in the same cache line.

The detection unit 502 may detect a loop process designated by an instruction statement in the target program as the target loop process. The instruction statement is an instruction statement to a compiler that may be arbitrarily designated by the user in the target program (source program). For example, in a case of FORTRAN, the instruction statement is an ocl statement. In a case of C language, the instruction statement is a text string starting with “#pragma”.

Therefore, the detection unit 502 may detect a loop process that is to be a high-cost loop, which is designated in advance by the user, as the target loop process.

The detection unit 502 may detect a target loop process from the target program, based on execution information obtained by executing the target program. The execution information is, for example, profile information, event information, or the like.

The profile information is information representing an execution cost or a data access situation obtained by a profiler, and includes, for example, the number of times of execution for each of loop process or statement included in the target program, the number of times of array access, and the like. The event information is information that may be acquired from a performance counter of the CPU 401, and indicates, for example, the number of occurrences of SFI, a delay cycle, and the like.

The event information is acquired by, for example, a general-purpose tool (performance analysis tool) such as perf. The detection unit 502 may detect a target loop process from the target program, based on information on a loop structure or a data dependency relationship obtained in a case of translating the target program, static syntax information, and the like.

For example, the detection unit 502 may detect a loop process as the target loop process, which is a high-cost loop, by combining the profile information, the event information, the information on the loop structure or the data dependency relationship obtained during the translation, the static syntax information, and the like. For example, the detection unit 502 may determine that a loop process including a preceding store command and a subsequent load command, in which SFI occurs and an execution cost is equal to or higher than a threshold value and which is a high-cost loop, and may detect the loop process as the target loop process.

The detection unit 502 may generate a learning model for detecting a target loop process by performing machine learning by combining the profile information, the event information, the information on the loop structure or the data dependency relationship obtained during the translation, the static syntax information, and the like. The detection unit 502 may detect a target loop process from the profile information or the like by using the generated learning model.

In the following description, in a store command included in a target loop process and a load command subsequent to the store command, the store command may be denoted as a “preceding store command”, and the load command may be denoted as a “subsequent load command”.

The subsequent load command is executed, for example, immediately after the preceding store command. Meanwhile, depending on scheduling, another command such as an arithmetic command may be inserted between the preceding store command and the subsequent load command. Therefore, in the following description, a case where the subsequent load command is unrolled immediately after the preceding store command will be described as an example, but the present embodiment is not limited thereto.

The configuration change unit 503 changes the detected target loop process to an initial loop (first loop process), a kernel loop (second loop process), and an end loop (third loop process). The initial loop is a loop process of executing the preceding store command in advance for the first number of times among the number of loop rotations (the number of iteration times) of the target loop process such that an access address of the preceding store command and an access address of the subsequent load command are not in the same cache line.

The cache line corresponds to an access unit from a processor (for example, the CPU 401) to a memory (for example, the memory 402). The kernel loop is a loop process of executing the preceding store command and the subsequent load command for the second number of times obtained by subtracting the first number of times from the number of loop rotations of the target loop process after the initial loop. The end loop is a loop process of executing the subsequent load command for the first number of times after the kernel loop.

For example, the configuration change unit 503 calculates the first number of times, based on a difference in access address between the preceding store command and the subsequent load command, a data size of a process unit, and a cache line size. The process unit is a process uniting the preceding store command and the subsequent load command, and is, for example, an element size of an array. The cache line size corresponds to a data size of an access unit from a processor to a memory.

For example, the configuration change unit 503 may calculate the first number of times, by dividing a value obtained by subtracting a size corresponding to the difference in access address from the cache line size by the element size. The size corresponding to the difference in access address corresponds to, for example, a value obtained by multiplying the difference in access address (the number of elements) by the element size.

The configuration change unit 503 sets a control variable of the initial loop, a control variable of the kernel loop, and a control variable of the end loop, based on the calculated first number of times. The control variable includes, for example, an initial value, an end value, and an increment value. The initial value is a value of the control variable in the first loop. The end value is a value of the control variable in the last loop. The increment value is an increment value of the control variable that is changed for each loop. The initial value and the increment value of the initial loop are specified from, for example, the control variable of the target loop process.

The translation unit 504 generates a machine language program corresponding to the target program after the change. The target program after the change is a target program in which the target loop is changed to the initial loop, the kernel loop, and the end loop. The machine language program is, for example, an object code. For example, the machine language program is generated by translating the target program after the change.

The information processing apparatus 101 may execute the target program based on, for example, the generated machine language program. For example, the information processing apparatus 101 creates an executable file from the machine language program, and executes the created executable file.

The information processing apparatus 101 may output, for example, the generated machine language program. Examples of an output format include storage in a storage device such as the memory 402 and the disk 404, and transmission to another computer through the communication I/F 405. Therefore, the information processing apparatus 101 may execute the optimized target program in, for example, another computer.

In a case where an instruction to optimize a target program is received, the information processing apparatus 101 may execute optimization on the target program. For example, the reception unit 501 receives an instruction to optimize the target program. In a case where the detection unit 502 receives an instruction to optimize the target program, a target loop process may be detected from the target program. Therefore, the information processing apparatus 101 may execute optimization on the target program by the present compiling method only in a case where there is an instruction from the user, for example.

The information processing apparatus 101 may change a loop configuration of an array in the detected target loop process to unroll an object code for avoiding SFI (-KavoidSFI) by a compiler translation option. The information processing apparatus 101 may change a loop configuration of an array (A) in a loop process designated by the user to unroll an object code for avoiding SFI by a compiler translation option (-KavoidSFI(A)). A keyword of the compiler translation option (for example, KavoidSFI) may be arbitrarily set.

### (Operation Example of Information Processing Apparatus 101)

Next, an operation example of the information processing apparatus 101 will be described. Here, the program 300 illustrated in FIG. 3 will be described as an example of a target program.

In the loop process 310 in the program 300, access addresses of a preceding store command and a subsequent load command are different by 8 bytes. For example, an array subscript of the preceding store process is “S=1”, and the access addresses of the preceding store command and the subsequent load command are different by only one element. Therefore, a difference in access address between the preceding store command and the subsequent load command is 8 bytes for one element.

In this case, it is assumed that a command (store) for storing 64 bytes which is a total of 8 elements of 1-element 8-byte data in a consecutive memory region from a register is used in the preceding store command. It is assumed that a command (load) for reading 64 bytes which is a total of 8 consecutive elements, from a memory region to a register is used in the subsequent load command.

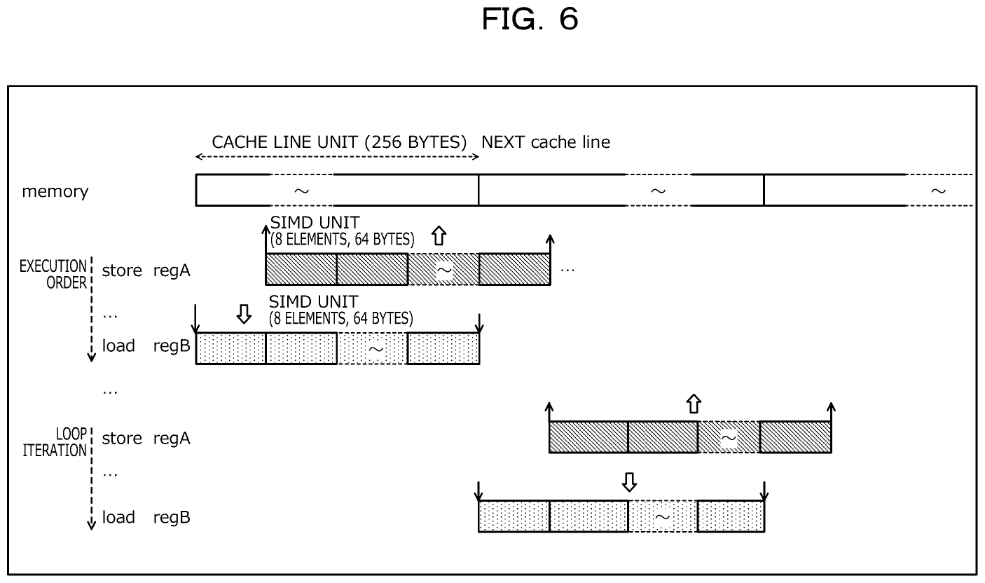

In a case where a relationship between the commands (store and load) is illustrated, the relationship is as illustrated in FIG. 6. Meanwhile, it is assumed that a cache line size is set to “256 bytes”.

FIG. 6 is an explanatory diagram illustrating a relationship between store and load. As illustrated in FIG. 6, an access addresses of a command (store) and an access addresses of a command (load) are in the same cache line. Therefore, in this state, SFI occurs, and performance of the program 300 is decreased.

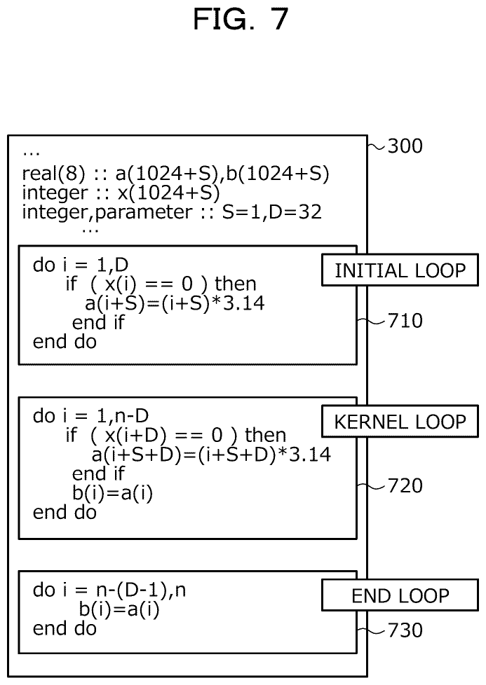

Therefore, the information processing apparatus 101 reconstructs a loop structure of the loop process 310 (see FIG. 3) including the preceding store command and the subsequent load command which cause SFI. For example, the information processing apparatus 101 changes the loop process 310 in the program 300 to three loop configurations (initial loop, kernel loop, and end loop) that are logically equal as illustrated in FIG. 7.

FIG. 7 is an explanatory diagram illustrating a program example after loop reconfiguration. In FIG. 7, the loop process 310 (see FIG. 3) in the program 300 is changed to an initial loop 710, a kernel loop 720, and an end loop 730.

The initial loop 710 is a loop process of executing a store command in advance to provide a difference in access address between the preceding store command and a subsequent load command which cause SFI such that the access addresses of the preceding store command and the subsequent load command are not in the same cache line.

Therefore, the information processing apparatus 101 avoids consecutive region accesses in which cache lines accessed by the preceding store command and the subsequent load command are the same.

For example, in the initial loop 710, the information processing apparatus 101 divides a loop by separating the preceding store command caused by SFI from the subsequent store command. More specifically, the information processing apparatus 101 extracts an if statement from an if statement [if (x(i)==0) then a(i+S)=(i+S)*3.14 end if] including the preceding store command and a move statement [b(i)=a(i)] including the subsequent load command having an SFI relationship, in the loop process 310, and constitutes a store command to be preceded as the initial loop 710.

Therefore, the information processing apparatus 101 may avoid accessing the same cache line by the preceding store command and the subsequent load command in the initial loop 710. In this case, for example, in the initial loop 710, the information processing apparatus 101 adjusts the number of rotations (the number of loop rotations) to execute the preceding store command in advance by one cache line length.

This number of rotations is the number of times that the preceding store command is repeatedly executed in the initial loop 710, and corresponds to the “first number of times” described above. A size corresponding to the difference in access address between the preceding store command and the subsequent load command is denoted as “A”, and an address of an array X(i) is denoted as &X(i).

In this case, in the example of the program 300, “A=&a(i+S)−&a(i)=8”. The cache line size is “256 bytes”, and the access address of the preceding store command is earlier than the access address of the subsequent load command. The information processing apparatus 101 sets the access address of the preceding store command to be a cache line different from the access address of the subsequent load command.

Therefore, the information processing apparatus 101 executes the preceding store command (store process for a preceding array), for example, in advance by “31 elements (D)” obtained by dividing the remaining byte length (256−8) to the next cache line size by an element size “8”. As a result, in the initial loop 710, the number of rotations is set to “31”, and a store process to the array is performed.

In the kernel loop 720 to be executed next, the respective access addresses of the preceding store command and the subsequent load command are adjusted to be in different cache lines. Therefore, the information processing apparatus 101 may respectively execute the preceding store command and the subsequent load command without occurrence of SFI, and may avoid a decrease in performance due to SFI.

For example, in the kernel loop 720, since the access addresses of the preceding store command and the subsequent load command are separated by one cache line size, SFI does not occur, and a decrease in performance may be avoided. The subsequent load command is first started in the kernel loop 720. Therefore, the information processing apparatus 101 sets a start position (initial value) of a control variable of the kernel loop 720 to the same start position “1” as before the change.

Meanwhile, the preceding store command is executed only from 1 to D in the initial loop 710. Therefore, in the kernel loop 720, the information processing apparatus 101 shifts a start position of the preceding store command by D (S+1+D). Since the information processing apparatus 101 executes only the subsequent load command in the end loop 730, an end position of a control variable of the kernel loop 720 is set to a value (n−D) obtained by subtracting the number of rotations before the change from D by which the store process is executed in advance in the initial loop 710.

In the subsequent execution end loop 730, since the preceding store command is executed in advance, only the remaining subsequent load command is executed to adjust the total processing amount. For example, in the end loop 730, the information processing apparatus 101 executes the load process by the remaining D, which deviates in the kernel loop 720. Therefore, the information processing apparatus 101 may make an execution order and the number of times of execution of the preceding store command and the subsequent load command the same before and after the change of the loop configuration.

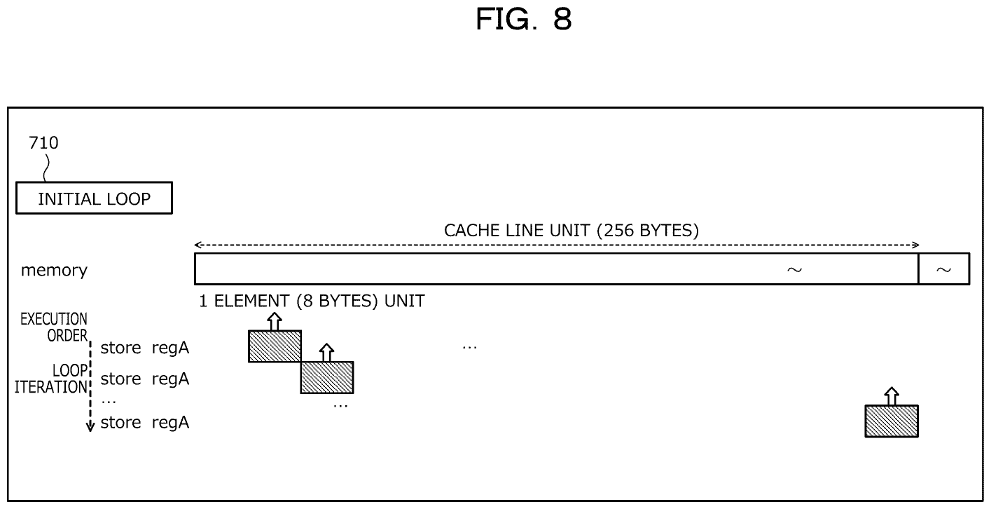

In a case where a relationship between the commands (store and load) in each loop (initial loop 710, kernel loop 720, and end loop 730) after the change of the loop configuration is illustrated, the relationship is as illustrated in FIGS. 8, 9A, 9B, and 10. Meanwhile, it is assumed that a cache line size is set to “256 bytes”.

FIG. 8 is an explanatory diagram illustrating a relationship between commands in an initial loop. As illustrated in FIG. 8, in the initial loop 710, a command (store) is executed in advance to provide a difference in access address between a preceding store command and a subsequent load command which cause SFI. In FIG. 8, the command (store) corresponds to a store process of writing in a memory region from a register in units of one element (8 bytes).

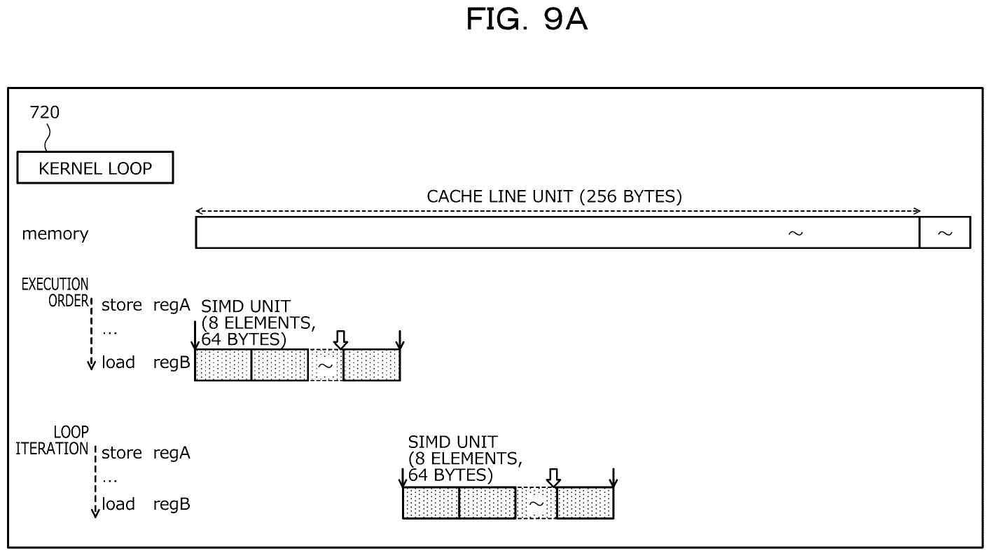

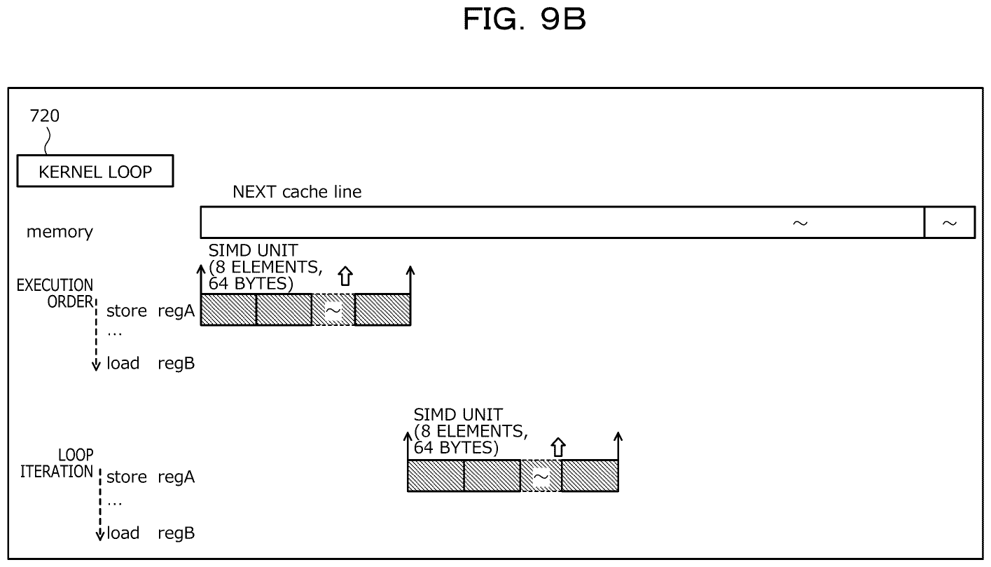

FIGS. 9A and 9B are explanatory diagrams illustrating a relationship between commands in a kernel loop. As illustrated in FIGS. 9A and 9B, in the kernel loop 720, the preceding store command and the subsequent load command are respectively executed, but SFI does not occur since access addresses of the preceding store command and the subsequent load command are separated by one cache line size.

In FIG. 9A, the command (load) corresponds to a load process of reading 64 bytes which is a total of 8 consecutive elements, from the memory region to the register. In FIG. 9B, the command (store) corresponds to a store process of writing 64 bytes which is a total of 8 elements of 1-element 8-byte data, from the register to a consecutive memory region.

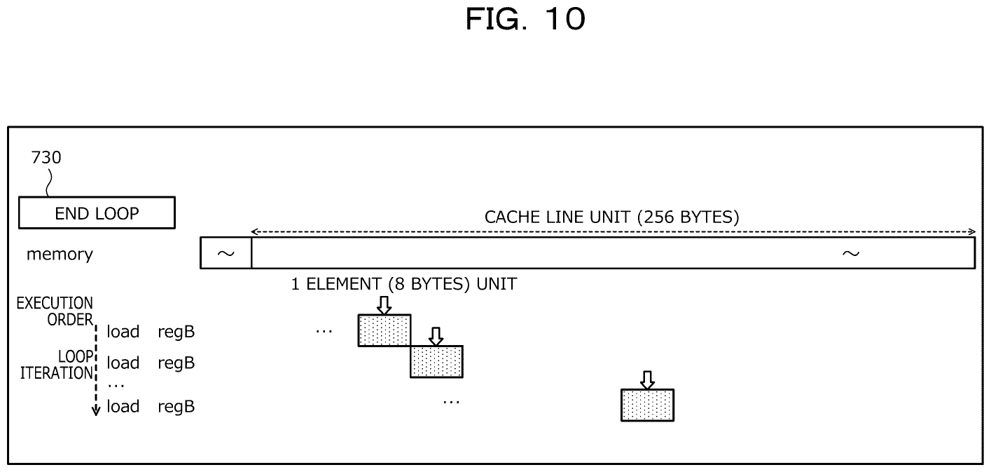

FIG. 10 is an explanatory diagram illustrating a relationship between commands in an end loop. As illustrated in FIG. 10, in the end loop 730, only the remaining subsequent load command is executed to adjust the total processing amount. In FIG. 10, the command (load) corresponds to the load process of reading from the memory region into the register in units of one element (8 bytes).

In this manner, with the information processing apparatus 101, in a case where SFI occurs in a high-cost process (loop process 310), a loop structure may be reconfigured to provide a difference in access address between the preceding store command and the subsequent load command. Therefore, the information processing apparatus 101 may avoid an access to the nearby address that is the same cache line for the store command and the load command.

### (Compiling Process Procedure of Information Processing Apparatus 101)

Next, a compiling process procedure of the information processing apparatus 101 will be described.

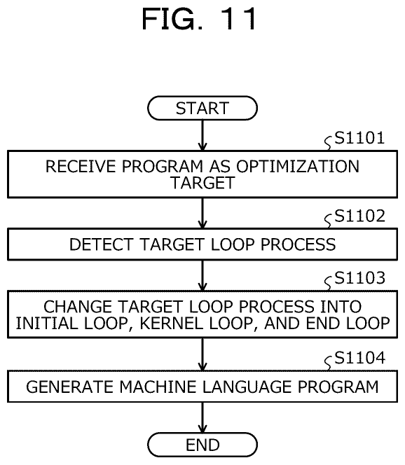

FIG. 11 is a flowchart illustrating an example of the compiling process procedure of the information processing apparatus 101. In a flowchart in FIG. 11, first, the information processing apparatus 101 receives a program as an optimization target (step S1101).

The information processing apparatus 101 detects a target loop process including a store command and a load command subsequent to the store command, from the received program (step S1102). The target loop process is, for example, a loop process including a preceding store command and a subsequent load command for the same array, in which a value obtained by multiplying a difference in access address between the preceding store command and the subsequent load command by an element size is less than a cache line size.

Next, the information processing apparatus 101 changes the detected target loop process into an initial loop, a kernel loop, and an end loop (step S1103). The initial loop is a loop process of executing the preceding store command in advance for the first number of times among the number of iteration times of the target loop process such that access addresses of the preceding store command and the subsequent load command are not in the same cache line.

The kernel loop is a loop process of executing the preceding store command and the subsequent load command for the second number of times obtained by subtracting the first number of times from the number of iteration times of the target loop process after the initial loop. The end loop is a loop process of executing the subsequent load command for the first number of times after the kernel loop.

The information processing apparatus 101 generates a machine language program corresponding to the target program after the change (step S1104), and ends a series of processes according to the present flowchart.

Therefore, the information processing apparatus 101 may reduce a decrease in performance due to SFI by changing a high-cost process (target loop process) into three loop configurations that are logically equal.

### Example 1

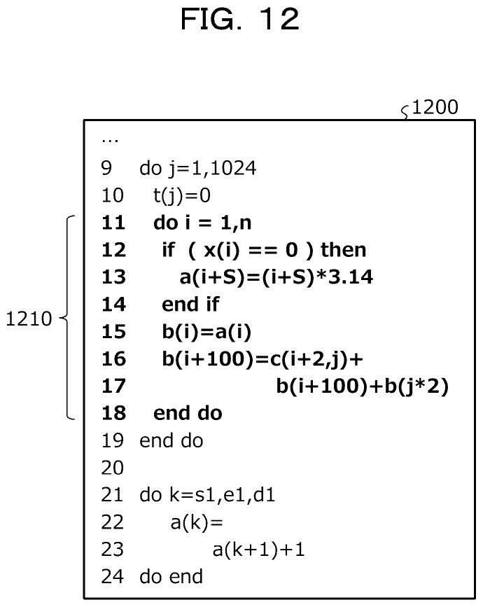

Next, Example 1 of the present compiling method will be described. First, a target program (program as an optimization target) will be described with reference to FIG. 12.

FIG. 12 is an explanatory diagram illustrating an example of the target program. In FIG. 12, a target program 1200 includes iteration (for example, loop process 1210) described by a do statement. The loop process 1210 corresponds to an innermost loop. A number in a left corner in the target program 1200 indicates a line number.

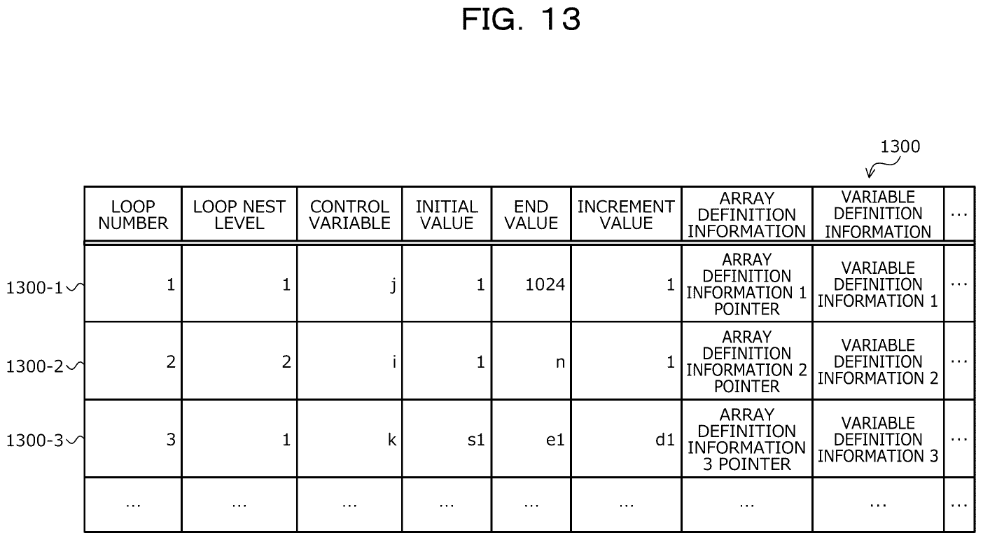

Next, storage contents of a DO loop management table will be described with reference to FIG. 13. The DO loop management table stores management information on a loop process, for each loop process corresponding to a source program (for example, the target program 1200). Even in a case of loop iteration other than the do statement, the case which is syntactically the same as the do statement is also included in the loop process. The DO loop management table is created by, for example, performing syntactic analysis on the target program 1200.

FIG. 13 is an explanatory diagram illustrating an example of the storage contents of the DO loop management table. In FIG. 13, a DO loop management table 1300 has fields of a loop number, a loop nest level, a control variable, an initial value, an end value, an increment value, array definition information, and variable definition information. By setting information in each field, DO loop management information (for example, DO loop management information 1300-1 to 1300-3) is stored as a record.

The loop number is a number created for each loop process described in the program. In the target program 1200 illustrated in FIG. 12, since three loop processes appear, three loop numbers (1, 2, and 3) are prepared.

The loop nest level indicates a multiplicity of the loop process. In a case where there is no nest, the multiplicity is “1”. For example, in the target program 1200, the multiplicity of the loop process of the loop number “2” is “2”. The loop nest level corresponding to the loop number “2” is “2”. The multiplicity of the loop process of the other loop numbers “1” and “3” is “1”.

The control variable is a control variable of the loop process. In a case where “do i=is, ie, id” is described in a do statement of Fortran, the control variable is “i”. In the target program 1200, the control variable corresponding to the loop number “2” is “i”.

The initial value is an initial value of the control variable of the loop process. A value of the control variable in the first loop is stored in the initial value. In a case where “do i=is, ie, id” is described in a do statement of Fortran, the initial value is “is”. In the target program 1200, the initial value of the control variable corresponding to the loop number “2” is “1”.

The end value is an end value of the control variable of the loop process. A value of the control variable in the last loop process is stored in the end value. In a case where “do i=is, ie, id” is described in a do statement of Fortran, the end value is “ie”. In the target program 1200, the end value of the control variable corresponding to the loop number “2” is “n”.

The increment value is an increment value of the control variable of the loop process. The increment value of the control variable to be changed for each loop is stored in the increment value. In a case where “do i=is, ie, id” is described in a do statement of Fortran, the increment value is “id”. In the target program 1200, the increment value of the control variable corresponding to the loop number “2” is “1”, and is not denoted.

The array definition information is a pointer pointing a table of array definition information on an array that appears in the loop process. In the target program 1200, the array definition information corresponding to the loop number “2” points to a table of array definition information 2.

The variable definition information is a pointer pointing a table of variable definition information on a variable that appears in the loop process. In the target program 1200, the variable definition information corresponding to the loop number “2” points to a table of variable definition information 2.

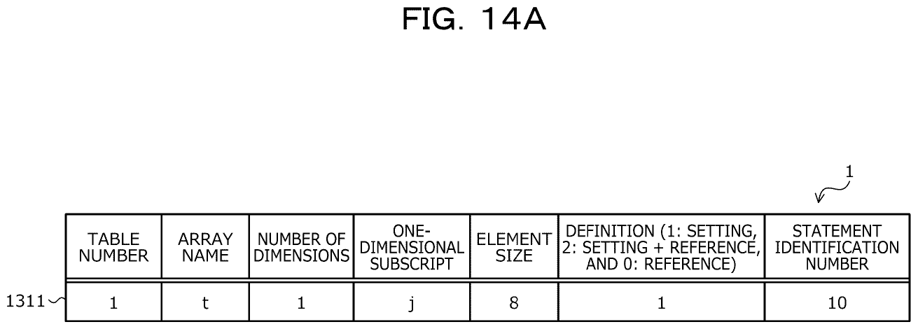

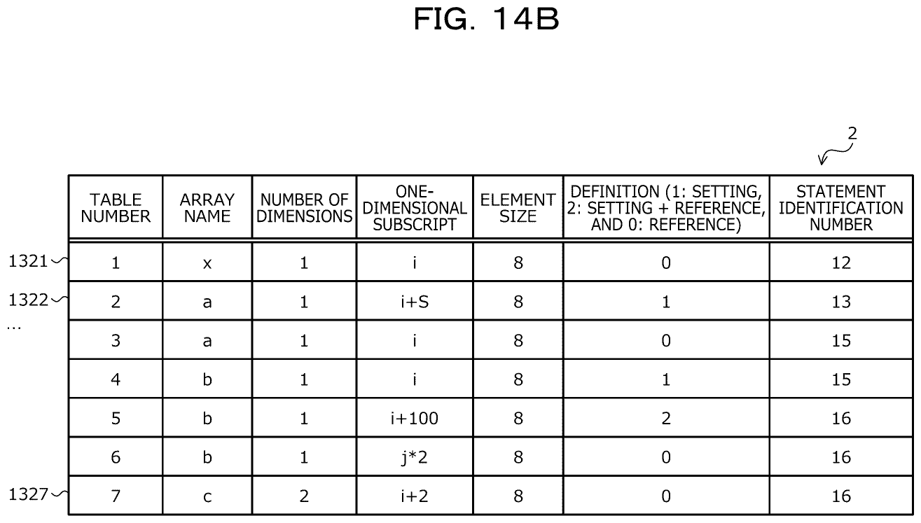

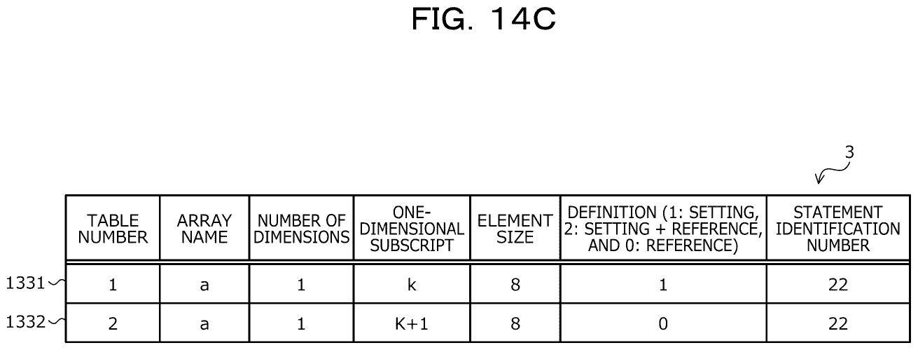

Next, storage contents of array definition information (array definition information 1, 2, and 3) will be described with reference to FIGS. 14A, 14B, and 14C. In the array definition information (array definition information 1, 2, and 3), for each line (statement identification number) that appears in a loop process of a source program (for example, the target program 1200), an array definition of an array that appears is stored.

FIGS. 14A, 14B, and 14C are explanatory diagrams illustrating an example of the storage contents of the array definition information. In FIGS. 14A, 14B, and 14C, the array definition information 1, 2, and 3 have fields of a table number, an array name, the number of dimensions, a one-dimensional subscript, an element size, a definition (1: setting, 2: setting+reference, and 0: reference), and a statement identification number. By setting information in each field, an array definition (for example, array definitions 1311, 1321 to 1327, 1331, and 1332) is stored as a record.

The table number is the number of an array created for each line described in the program. In a case where there are a plurality of arrays in the same line, the number is assigned for each order to be processed. The array name is an array name defined in the program. In an example of the array definition information 2, as arrays corresponding to the loop number “2”, x, a, b, and c are stored for each statement identification number.

The number of dimensions indicates the number of dimensions of the array. The one-dimensional subscript indicates a subscript having one dimension. Here, a case is assumed in which it is determined whether or not access addresses of a store command and a load command are in the same cache line. A consecutive access in a two-dimensional or more array access including a one-dimensional array as an array is a one-dimensional access. Therefore, the one-dimensional subscript is stored to check only the one-dimensional access. In the example of the array definition information 2, the one-dimensional subscript of the array a of the statement identification number “13” corresponding to the loop number “2” is “i+S”.

The element size is a size of an element of the array. The definition is any of “1: setting”, “2: setting+reference”, or “0: reference”. For example, in a case of performing a store process as a statement, the definition is “1: setting”. in a case where the store process and a load process for the same array element appear in one statement, the definition is “2: setting+reference”. In this case, data writing occurs as the store process, but data reading is performed first since the same array element is used. In a case where a preceding load and a subsequent store are performed, SFI does not occur. In a case of a load process as a statement, the definition is “0: reference”.

The statement identification number indicates a corresponding line in the program. Meanwhile, the statement identification number created by a compiler may not strictly correspond to the line number. For example, in the target program 1200, “b(i+100)=c(i+2, j)+b(i+100)+b(j*2)” in the 16th and 17th lines is two lines as a source description, but is one line as an assignment statement since one statement is formed. Therefore, in the array definition information 2, the statement identification number of the array b(i+100), b(j*2) in the 17th line is “16” which is the same as b(i+100), c(i+2, j) defined in the 16th line which is the same statement.

The information processing apparatus 101 detects a target loop process from the target program 1200 with reference to, for example, the DO loop management table 1300 illustrated in FIG. 13. For example, the information processing apparatus 101 refers to array definition information corresponding to each loop number in the DO loop management table 1300 to search for a case which causes SFI.

A case of searching for a case which causes SFI will be described with reference to the array definition information 2 illustrated in FIG. 14B. An element size of an array is set to “8 bytes”, and a cache line size is set to “256 bytes”. A variable S included in the target program 1200 is set to “S=1”.

First, the information processing apparatus 101 specifies a table number i from a head to a trailing end of the array definition information 2. Here, the table numbers 1 to 7 (i=1, 2, . . . , 7) are specified.

The information processing apparatus 101 searches for an array which exists at an access destination for a store process and a load process which cause SFI occurrence and which satisfies all of the following conditions (i) to (iv), for consecutive table numbers “i” and “i+1” of the array definition information 2 (i=1 to last−1).

ARRAY_TBL(i)·array=ARRAY_TBL(i+1)·array (i)

Meanwhile, ARRAY_TBL(i).array indicates an array of the table number i in the array definition information. In the example of the array definition information 2, when “i=2”, the same array a is obtained, and the condition (i) is satisfied. Hereinafter, a case of “i=2” satisfying the condition (i) will be described as an example.

|ARRAY_TBL(i)·one-dimensional subscript−ARRAY_TBL(i+1)·one-dimensional subscript|*element size<cachelinesize (ii)

Meanwhile, ARRAY_TBL(i).one-dimensional subscript indicates a one-dimensional subscript of an array of the table number i in the array definition information. In the example of the array definition information 2, in a case of “i=2”, “ARRAY_TBL(2).one-dimensional subscript=i+S” and “ARRAY_TBL(3).one-dimensional subscript=i” are satisfied.

The element size is “8 bytes”. The cachelinesize (cache line size) is “256 bytes”. The variable S is “S=1”. In this case, “|(i+1)−i|*8<256” is satisfied, and thus the condition (ii) is satisfied.

ARRAY_TBL(i)·definition=1(set), and ARRAY_TBL(i+1)·definition=0(reference) (iii)

Meanwhile, ARRAY_TBL(i).definition indicates a definition of the table number i in the array definition information. In the example of the array definition information 2, in a case of “i=2”, “ARRAY_TBL(2).definition=1 (setting)” and “ARRAY_TBL(3).definition=0 (reference)”. In this case, the condition (iii) is satisfied.

ARRAY_TBL(i)·statement identification number ARRAY_TBL(i+1)·statement identification number (iv)

Meanwhile, ARRAY_TBL(i).statement identification number indicates a statement identification number of the table number i in the array definition information. In the example of the array definition information 2, in a case of “i=2”, “ARRAY_TBL(2).statement identification number=13” and “ARRAY_TBL(3).statement identification number=15”. In this case, the condition (iv) is satisfied.

The information processing apparatus 101 detects a loop process including a preceding store command and a subsequent load command for an array satisfying all of the conditions (i) to (iv) as a target loop process. It may be said that the array satisfying all of the conditions (i) to (iv) is an array as an SFI target.

For example, in a case where the conditions (i), (iii), and (iv) are satisfied, it may be said that there is a loop process including a preceding store command and a subsequent load command for the same array. In a case where the condition (ii) is satisfied, it may be said that the loop process is a loop process in which a value obtained by multiplying a difference in access address between the preceding store command and the subsequent load command by the element size is less than the cache line size.

By command scheduling of a compiler, it may be possible to insert another command that may conceal an interlock cycle of SFI between the store command and the load command. Therefore, in a case where the another command that may conceal the interlock cycle of the SFI may not be inserted, the information processing apparatus 101 may detect the loop process including the preceding store command and the subsequent load command for the array satisfying all of the conditions (i) to (iv) as the target loop process.

In the target program 1200, for example, the loop process 1210 (see FIG. 12) is detected as the target loop process.

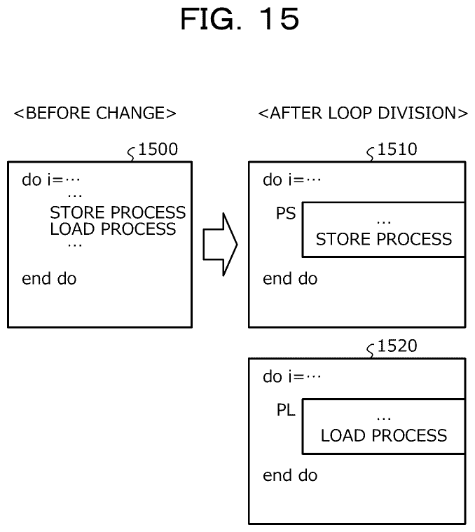

Next, the information processing apparatus 101 changes the detected target loop process (for example, the loop process 1210) to three loop configurations (initial loop, kernel loop, and end loop) that are logically equal. Hereinafter, a specific process example in a case where a loop configuration is changed will be described with reference to FIGS. 15 to 20.

FIG. 15 is an explanatory diagram illustrating a loop division example. In FIG. 15, a loop 1500 is a simplified representation of a target loop process. First, the information processing apparatus 101 decomposes the loop 1500 into two loops. For example, the information processing apparatus 101 divides the loop 1500 into a loop 1510 including a preceding store process (PS) and a loop 1520 including a subsequent load process (PL).

Therefore, the information processing apparatus 101 separates the preceding store process (PS) and the subsequent load process (PL) that cause SFI. In this case, logically, the number of rotations of the loops 1510 and 1520 divided into two loops are preferably the same as those before the division. Since a loop division method is an existing technology, a detailed description thereof will be omitted.

A division example of a source code will be described by using the loop process 1210 illustrated in FIG. 12 as an example.

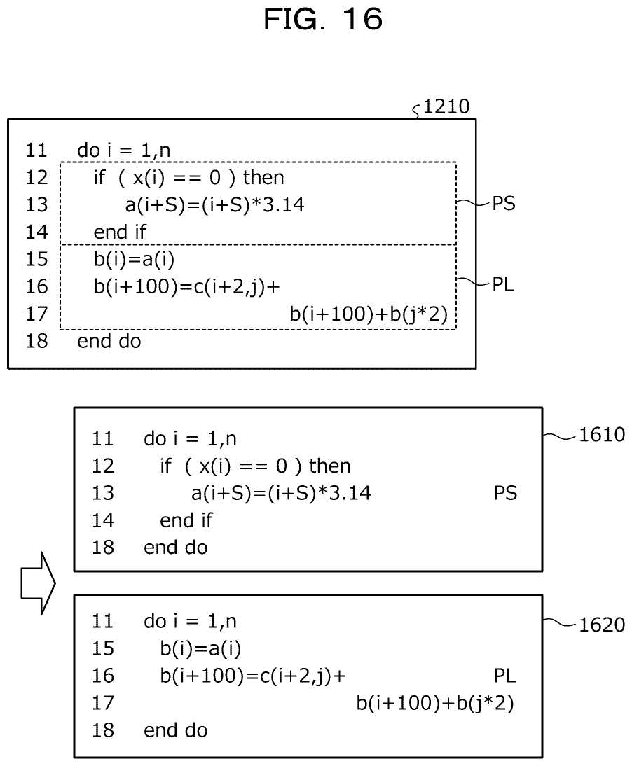

FIG. 16 is an explanatory diagram illustrating the division example of the source code. In FIG. 16, the loop process 1210 corresponds to a target loop process detected from the target program 1200 (see FIG. 12). The loop process 1210 includes the preceding store process PS and the subsequent load process PL.

The information processing apparatus 101 divides the loop process 1210 into a loop process 1610 including the store process (PS) and a loop process 1620 including the load process (PL). The preceding store process (PS) corresponds to a preceding store command. The subsequent load process (PL) corresponds to a subsequent load command.

Next, the information processing apparatus 101 changes the divided loop 1510 (for example, the loop process 1610) and the loop 1520 (for example, the loop process 1620) to three loop configurations (initial loop, kernel loop, and end loop). In the initial loop, only the store process (PS) is executed. In the kernel loop, the store process (PS) and the load process (PL) are executed. In the end loop, only the load process (PL) is executed.

Before and after the loop configuration is changed, an execution order and the number of times of execution of the store process (PS) and the load process (PL) are the same without a change. The information processing apparatus 101 adjusts the division into the three loop configurations such that the load process (PL) does not overtake the store process (PS). In order to make the same numbers of times of execution before and after changing the loop configuration, the information processing apparatus 101 sets a control variable (initial value, end value, and increment value) of the three loops such that the number of times of unrolling of each loop is the same as before the change.

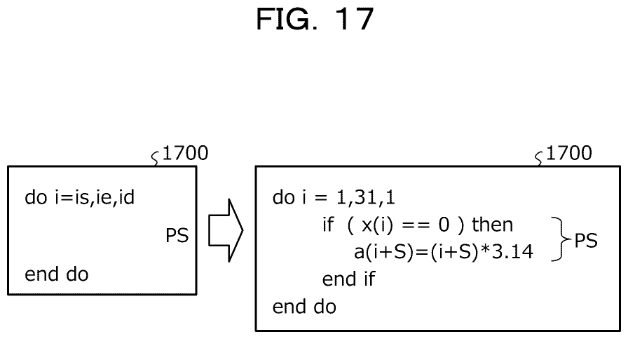

First, an initial loop will be described with reference to FIG. 17. The number of rotations before the loop configuration is changed (the number of loop rotations) may be denoted by “n”. In the example of the loop process 1210, n is “1024” (see FIG. 12).

FIG. 17 is an explanatory diagram illustrating an example of the initial loop. In FIG. 17, an initial loop 1700 includes the store process (PS). The information processing apparatus 101 adjusts to execute the store process (PS) in advance in the initial loop 1700 until a difference in access address between the store process (PS) and the load process (PL) for an array which is an SFI target exceeds one cache line size (cachelinesize).

For example, the information processing apparatus 101 calculates the number of array elements (D) in the store process (PS) to be executed in advance in the initial loop 1700 using Expression (1) to be described below.

D=(cachelinesize−|ARRAY_TBL(i)·one-dimensional subscript−ARRAY_TBL(i+1)·one-dimensional subscript|*element size)/element size (1)

Here, “ARRAY_TBL(2).one-dimensional subscript=i+S” and “ARRAY_TBL(3).one-dimensional subscript=i”, and a difference in access address between the preceding store process (PS) and the subsequent load process (PL) is “8 bytes”. The cache line size is “256 bytes”.

Therefore, the number of array elements (D) is “D=(256−|(i+1)−i|*8)/8=31”. The access address of the preceding store process (PS) is larger than the access address of the subsequent load process (PL) by 8 bytes. The information processing apparatus 101 adjusts to execute the store command of the array element in advance by remaining (256-8)/8=31 elements (D) to make the cache line different.

In this case, the number of rotations (the number of loop rotations) of the initial loop 1700 is D. The information processing apparatus 101 calculates a control variable (initial value: is, end value: ie, and increment value: id) of the initial loop 1700 as follows. Meanwhile, DO_TBL(I).initial value and DO_TBL(I).increment value are an initial value and an increment value corresponding to the loop number: I in the DO loop management table 1300 corresponding to array definition information as an SFI target.

$$is = DO\_TBL ( I ) \cdot initial value \\ ie = DO\_TBL ( I ) \cdot initial value + D - 1 \\ id = DO\_TBL ( I ) \cdot increment value$$

Here, a loop number in the DO loop management table 1300 corresponding to the array definition information 2 as an SFI target is “2”. Therefore, the control variables of the initial loop 1700 (initial value: is, end value: ie, and increment value: id) are calculated as follows.

$$is = DO\_TBL ( 2 ) \cdot initial value = 1 \\ ie = DO\_TBL ( 2 ) \cdot initial value + D - 1 = 1 + 31 - 1 = 31 \\ id = DO\_TBL ( 2 ) \cdot increment = 1$$

The information processing apparatus 101 sets each of the calculated values (is, ie, id) as the control variable of the initial loop 1700 (see a right side in FIG. 17).

In the example described above, a case where one cache line size (256 bytes) is left empty to avoid SFI is described, but the present embodiment is not limited thereto. For example, depending on a processor, the difference in access address which causes SFI occurrence may be two or more cache line sizes, or may be a different management unit different from the cache line size. In such a case, the information processing apparatus 101 may calculate the number of rotations D of the preceding store process (PS) in accordance with the size.

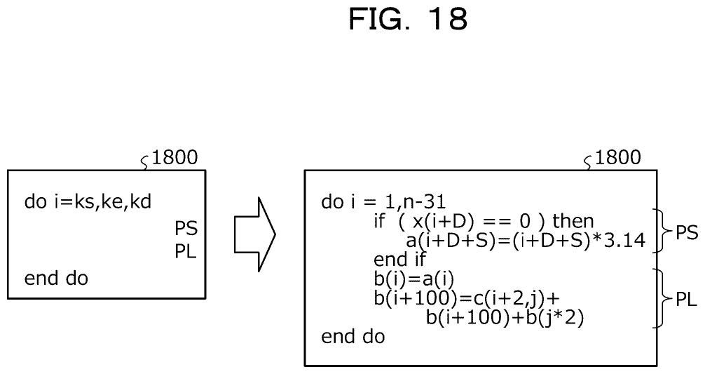

Next, a kernel loop will be described with reference to FIG. 18.

FIG. 18 is an explanatory diagram illustrating an example of the kernel loop. In FIG. 18, a kernel loop 1800 includes the store process (PS) and the load process (PL). In the preceding store process (PS), a process is performed from 1 to the number of array elements (D) in the initial loop 1700. Therefore, in the store process (PS), execution of the (n−D) elements remains (n is the number of rotations before the loop configuration change).

In the kernel loop 1800, the load process (PL) is also executed in the same loop. Therefore, the information processing apparatus 101 sets the number of rotations of the kernel loop 1800 to “n−D”. In a case of an SIMD command is unrolled, the number of rotations of the kernel loop 1800 may be the number of rotations obtained by dividing the number of rotations by an integral multiple of an SIMD width. Meanwhile, here, the number of rotations is simplified to “n−D” without consideration.

The information processing apparatus 101 calculates a control variable (initial value: ks, end value: ke, and increment value: kd) of the kernel loop 1800 as follows.

$$ks = DO\_TBL ( I ) \cdot initial value = 1 \\ ke = DO\_TBL ( I ) \cdot initial value + ( n - D ) - 1 \\ kd = DO\_TBL ( I ) \cdot increment value$$

The initial value (ks) is the same as an initial value corresponding to the loop number: I in the DO loop management table 1300 corresponding to array definition information as an SFI target. On the other hand, since the number of rotations is “n−D”, the end value (ke) is “DO_TBL(I).initial value+(n−D)−1” by using the initial value of the loop number: I in the DO loop management table 1300. The increment value (kd) is the same as an increment value of the loop number: I in the DO loop management table 1300 corresponding to the array definition information as an SFI target.

Here, a loop number in the DO loop management table 1300 corresponding to the array definition information 2 as an SFI target is “2”. The number of rotations D is “D=31”. Therefore, the control variables (initial value: ks, end value: ke, and increment value: kd) of the kernel loop 1800 are calculated as follows.

$$ks = DO\_TBL ( 2 ) \cdot initial value = 1 \\ ke = 1 + n - 31 - 1 = n - 31 \\ kd = DO\_TBL ( 2 ) \cdot increment value = 1$$

The information processing apparatus 101 sets each of the calculated values (ks, ke, and kd) as the control variables of the kernel loop 1800 (see a right side in FIG. 18).

In the initial loop 1700, the preceding store process (PS) is processed by the number of array elements (D) from 1. The same value as the initial value of the initial loop 1700 is used as an initial value of the control variable of the kernel loop 1800. Therefore, in the kernel loop 1800, the subscript (i) and the variable i of the array in the store process (PS) are changed such that the store process (PS) is not executed twice on the same array.

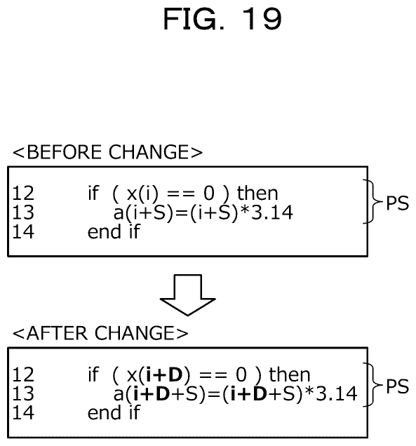

FIG. 19 is an explanatory diagram illustrating an example of changing a subscript of an array. In FIG. 19, <BEFORE CHANGE> indicates the store process (PS) before changing the subscript (i) and the variable i of the array. <AFTER CHANGE> indicates the store process (PS) after changing the subscript (i) and the variable i of the array.

Here, the information processing apparatus 101 changes the subscript (i) and the variable i of the array to a value obtained by adding D to start the store process (PS) from the next element of the element D. For example, the information processing apparatus 101 changes “i” of the subscript (i) and the variable i of the array in the store process (PS) from “i” to “i+D”.

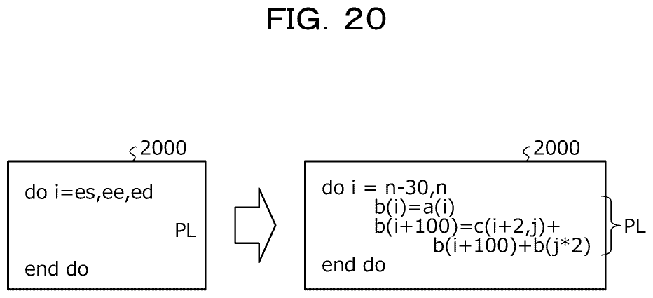

Next, an end loop will be described with reference to FIG. 20.

FIG. 20 is an explanatory diagram illustrating an example of the end loop. In FIG. 20, an end loop 2000 includes the load process (PL). Before and after the change of the loop configuration, the store process (PS) and the load process (PL) have the same execution order and the same number of times of execution. In the initial loop 1700, only the store process (PS) is executed in advance for the number of array elements (D).

Even in the kernel loop 1800, a relationship in which an access of the store process (PS) is executed earlier than the load process (PL) for the number of array elements (D) is maintained. Therefore, in the end loop 2000, the information processing apparatus 101 executes only the load process (PL) to make the total number of times of execution of the store process (PS) and the load process (PL) the same as the total number of times of execution before the loop configuration change.

The number of times of execution of the load process (PL) in the end loop 2000 is the same as the number of array elements (D) for which the store process (PS) is executed in advance in the initial loop 1700. In the end loop 2000, the load process (PL) is executed from the next element of the last element of the kernel loop 1800 to a trailing end.

For example, the information processing apparatus 101 sets the number of rotations of the end loop 2000 to “D” which is the same as the number of rotations of the initial loop 1700. The information processing apparatus 101 calculates a control variable (initial value: es, end value: ee, increment value: ed) of the end loop 2000 as follows.

$$es = DO\_TBL ( I ) \cdot end value - D + 1 \\ ee = DO\_TBL ( I ) \cdot end value \\ ed = DO\_TBL ( I ) \cdot increment value$$

In the end loop 2000, only the load process (PL) for the last remaining D elements is executed. Therefore, the initial value (es) of the control variable of the end loop 2000 is set to “DO_TBL(I).end value−D+1” by using an end value of the loop number: I in the DO loop management table 1300 corresponding to array definition information as an SFI target. The end value (ee) is the same as the end value of the loop number: I in the DO loop management table 1300. The increment (ed) is the same as the increment value of the loop number: I in the DO loop management table 1300.

Here, a loop number in the DO loop management table 1300 corresponding to the array definition information 2 as an SFI target is “2”. The number of rotations D is “D=31”. Therefore, the control variables (initial value: es, end value: ee, increment value: ed) of the end loop 2000 are calculated as follows.

$$es = DO\_TBL ( 2 ) \cdot end value - D + 1 = n - 31 + 1 = n - 30 \\ ee = DO\_TBL ( 2 ) \cdot end value = n \\ ed = DO\_TBL ( 2 ) \cdot increment value = 1$$

The information processing apparatus 101 sets each of the calculated values (es, ee, and ed) as the control variable of the end loop 2000 (see a right side in FIG. 20).

Assembler unrolling of the kernel loop 1800 after the loop configuration change will be described. Although a command set of an ARM processor will be described as an example, the same is applied to other processors, and the present embodiment is not limited to the ARM processor (ARM is a registered trademark).

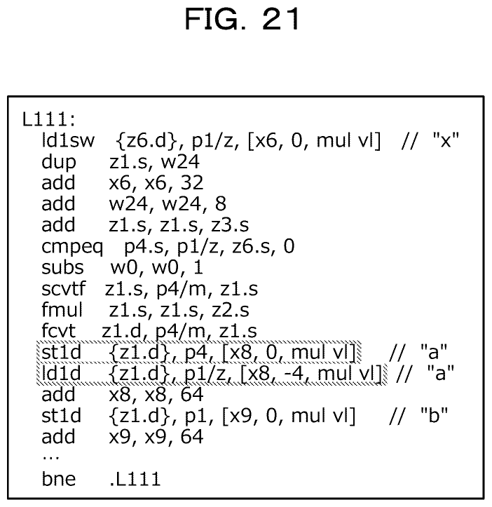

FIG. 21 is an explanatory diagram illustrating assembler unrolling of a kernel loop after a loop configuration change. A difference in access address between a store command (st1d) and a load command (Id1d) in the kernel loop 1800 is 64*4=256 bytes (=size of 1 cache line). Therefore, in the kernel loop 1800, the access addresses of the store command and the load command for the same cache line are not the same, and SFI may be avoided.

For example, in the kernel loop 1800, the access addresses of the preceding store process (PS) and the subsequent load process (PL) are separated from each other to be in different cache lines. Therefore, the preceding store process (PS) and the subsequent load process (PL) may be executed without occurrence of SFI, and a decrease in performance due to SFI may be avoided.

From these, the information processing apparatus 101 may change a high-cost loop in the target program 1200 into three loop configurations (initial loop, kernel loop, and end loop) that are logically equal. For example, in the initial loop, the information processing apparatus 101 shifts a timing of the process of the preceding store command and the subsequent load command which cause SFI, so that the access addresses of the preceding store command and the subsequent load command are not in the same cache line. Therefore, the information processing apparatus 101 avoids the consecutive region access in which the cache lines accessed by the preceding store command and the subsequent load command are the same.

In the kernel loop to be executed next, the information processing apparatus 101 may execute the preceding store and the subsequent load without occurrence of SFI in the same loop process since the respective access addresses of the preceding store command and the subsequent load command are in the different cache lines. Therefore, the information processing apparatus 101 may avoid interlock by SFI, and improve performance of the target program 1200.

Here, a case where the applicable array is loop-divided into other loops and then the loop configuration is changed with a focus on one loop is described as an example, but the present embodiment is not limited thereto. For example, the information processing apparatus 101 may change the loop configuration after combining the divided loops into one loop by loop fusion with another loop. The information processing apparatus 101 may apply the present compiling method by combining the present compiling method with other optimizations such as loop division, loop fusion, and scheduling over a plurality of loops after extracting a target array between the plurality of loops, and distributing the target array to an applicable array and a loop configuration.

### Example 2

Next, Example 2 of the present compiling method will be described. In Example 2, a case where a user explicitly designates a loop location and an array, which may be an SFI target, by using an ocl statement or the like in a source program (target program) will be described.

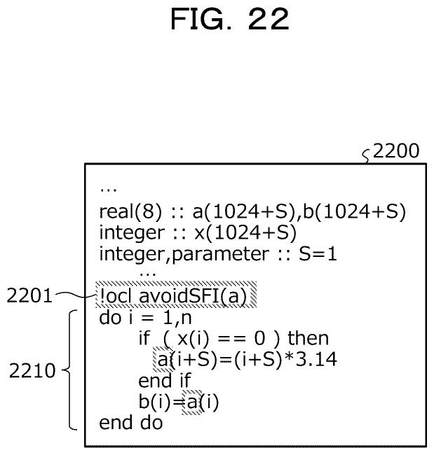

FIG. 22 is an explanatory diagram illustrating a program example including an ocl statement. In FIG. 22, a program 2200 includes iteration (loop process 2210) described in a do statement. In the program 2200, a loop location including an array name (a) to be avoided from SFI is explicitly designated by an ocl statement 2201.

The ocl statement is an instruction statement to a compiler starting with !ocl that may be arbitrarily designated by the user in a fortran source code. In this case, the information processing apparatus 101 avoids interlock caused by SFI occurrence by changing a loop configuration for the array a in the designated loop process 2210. A control instruction name (avoidSFI) of the ocl statement may be arbitrarily set.

Even in a case where the user does not explicitly designate the target loop process (loop process for SFI target and array) by the ocl statement or the like, the target loop process may be automatically detected by a compiler translation option. Meanwhile, there is a case where the compiler may not automatically detect the ocl statement, or there is a case where only a specific loop location is desired to be designated. In such a case, the information processing apparatus 101 may avoid the interlock caused by the occurrence of SFI by changing the loop configuration for the designated loop location by explicit designation by the user through the ocl statement or the like.

### Example 3

Next, Example 3 of the present compiling method will be described. In Example 3, a case where a target loop process (loop process of SFI target and array) is detected based on profile information and event information acquired at a time of executing a target program will be described.

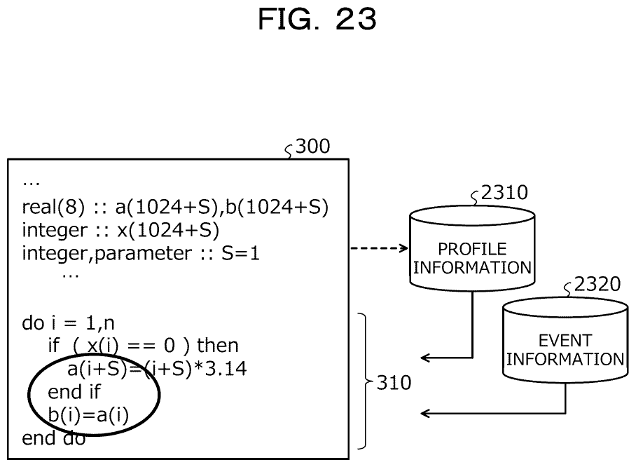

FIG. 23 is an explanatory diagram illustrating an operation example using profile information and the like. In FIG. 23, the program 300 is an example of the target program. The information processing apparatus 101 acquires profile information 2310 and event information 2320 by executing the program 300 in advance.

The information processing apparatus 101 detects a target loop process from the program 300, based on the acquired profile information 2310 and event information 2320. Here, the loop process 310 which is, for example, a high-cost loop and which is determined as a location to be avoided from SFI is detected from the profile information 2310 and the event information 2320.

A file output and input of the profile information and the event information may be designated by, for example, the following translation options.

For example, the information processing apparatus 101 may output the profile information to a file (prof1) by “-KavoidSFI_prof.out=prof1”. The information processing apparatus 101 may input the profile information from the file (prof1) by “-KavoidSFI_prof.in=prof1”. The information processing apparatus 101 may input the event information from a file (event1) by “-KavoidSFI_event.in=event1”.

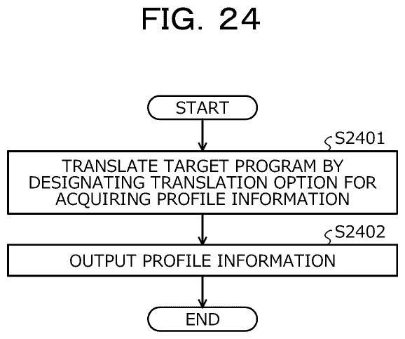

A profile information acquisition process procedure of the information processing apparatus 101 will be described with reference to FIG. 24.

FIG. 24 is a flowchart illustrating an example of the profile information acquisition process procedure of the information processing apparatus 101. In the flowchart in FIG. 24, first, the information processing apparatus 101 designates a translation option for profile information acquisition, and translates a target program (step S2401).

The information processing apparatus 101 executes the translated target program to output the profile information (step S2402), and ends a series of processes according to the present flowchart. Therefore, the information processing apparatus 101 may acquire the profile information of the target program.

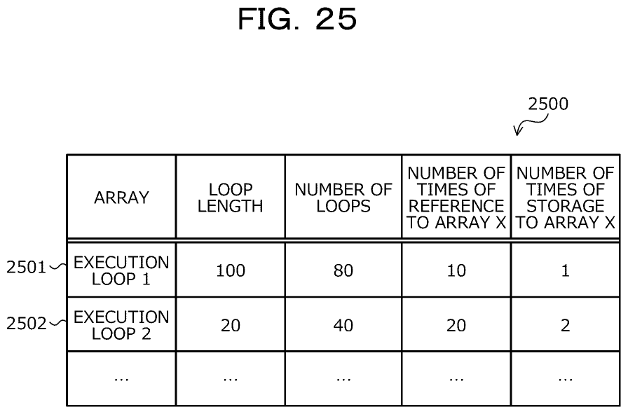

FIG. 25 is an explanatory diagram illustrating a specific example of the profile information. In FIG. 25, profile information 2500 includes loop information 2501 and 2502. Each of the loop information 2501 and 2502 has an array, a loop length, the number of loops, the number of times of reference to the array X, and the number of times of storage of the array X. The array indicates a loop including the array. The loop length indicates a length of the loop. The number of loops indicates the number of rotations of the loop.

The number of times of reference of the array X indicates the number of times of reference for the array. The number of times of storage to the array X indicates the number of times of storage for the array. The information processing apparatus 101 determines a location to be avoided from SFI, which is a high-cost loop, for example, with reference to the profile information 2500. For example, the information processing apparatus 101 may determine a loop having a relatively large number of loops as a location to be avoided from SFI.

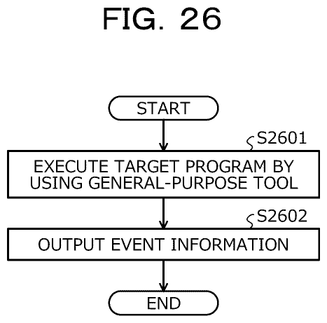

Next, an event information acquisition process procedure of the information processing apparatus 101 will be described with reference to FIG. 26.

FIG. 26 is a flowchart illustrating an example of the event information acquisition process procedure of the information processing apparatus 101. In the flowchart in FIG. 26, first, the information processing apparatus 101 executes a target program by using a general-purpose tool (step S2601). The general-purpose tool is, for example, software (for example, perf) for acquiring performance information.

The information processing apparatus 101 outputs event information acquired by the general-purpose tool (step S2602), and ends a series of processes according to the present flowchart. Therefore, the information processing apparatus 101 may acquire the event information of the target program.

### Example 4

Next, Example 4 of the present compiling method will be described. In Example 4, a case where a functional unit (for example, the detection unit 502, the configuration change unit 503, and the translation unit 504 illustrated in FIG. 5) of the information processing apparatus 101 is realized by a compiler will be described.

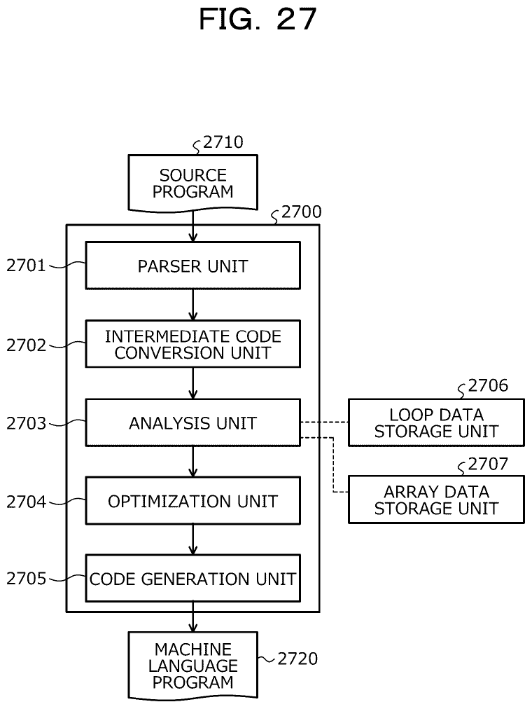

FIG. 27 is an explanatory diagram illustrating a configuration example of the compiler. In FIG. 27, a compiler 2700 includes a parser unit 2701, an intermediate code conversion unit 2702, an analysis unit 2703, an optimization unit 2704, and a code generation unit 2705.

The parser unit 2701 extracts a reserved word (keyword) and the like from a source program 2710 to be compiled, and performs lexical analysis. The intermediate code conversion unit 2702 converts each statement of the source program 2710, which is passed from the parser unit 2701, into an intermediate code based on a certain rule.

The analysis unit 2703 detects a target loop process (loop location and array which may be a SFI target) from the source program 2710. For example, the analysis unit 2703 detects the target loop process with reference to a DO loop management table stored in a loop data storage unit 2706 and array definition information stored in an array data storage unit 2707.

The analysis unit 2703 may detect a location designated by an ocl statement or the like in the source program 2710 as the target loop process. The analysis unit 2703 may detect the target loop process with reference to profile information and event information of the source program 2710. The detection unit 502 illustrated in FIG. 5 is realized by, for example, the analysis unit 2703.

The optimization unit 2704 performs an optimization process on the source program 2710. For example, the optimization unit 2704 changes the detected target loop process into three loop configurations (initial loop, kernel loop, and end loop) that are logically equal. The loop configuration change process by the optimization unit 2704 may be performed, for example, based on the intermediate code output from the intermediate code conversion unit 2702. The process by the parser unit 2701 and the intermediate code conversion unit 2702 may be performed on the source program 2710 on which the loop configuration change process is performed by the optimization unit 2704.

The optimization unit 2704 may improve an execution speed, reduce a code size, or the like by performing a process such as command combination, redundancy removal, and command rearrangement on the intermediate code output from the intermediate code conversion unit 2702. The configuration change unit 503 illustrated in FIG. 5 is realized by, for example, the optimization unit 2704.

The code generation unit 2705 generates a machine language program 2720 corresponding to the source program 2710 on which the optimization process is performed. For example, the code generation unit 2705 generates the machine language program 2720 by replacing all the codes with machine language commands, with reference to a conversion table (not illustrated) or the like, with respect to the intermediate code output from the optimization unit 2704. The translation unit 504 illustrated in FIG. 5 is realized by, for example, the code generation unit 2705.

### Example 5

Next, a specific process procedure of a compiling process of the information processing apparatus 101 will be described as Example 5.

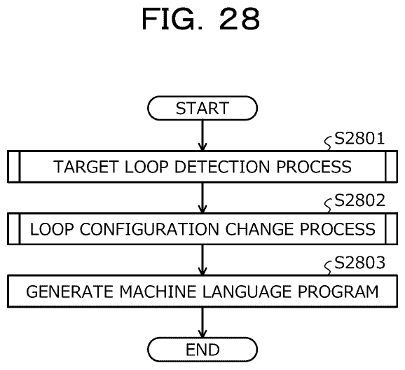

FIG. 28 is a flowchart illustrating an example of the specific process procedure of the compiling process of the information processing apparatus 101. In the flowchart in FIG. 28, first, the information processing apparatus 101 executes a target loop detection process (step S2801). The target loop detection process is a process of detecting a target loop process from a target program.

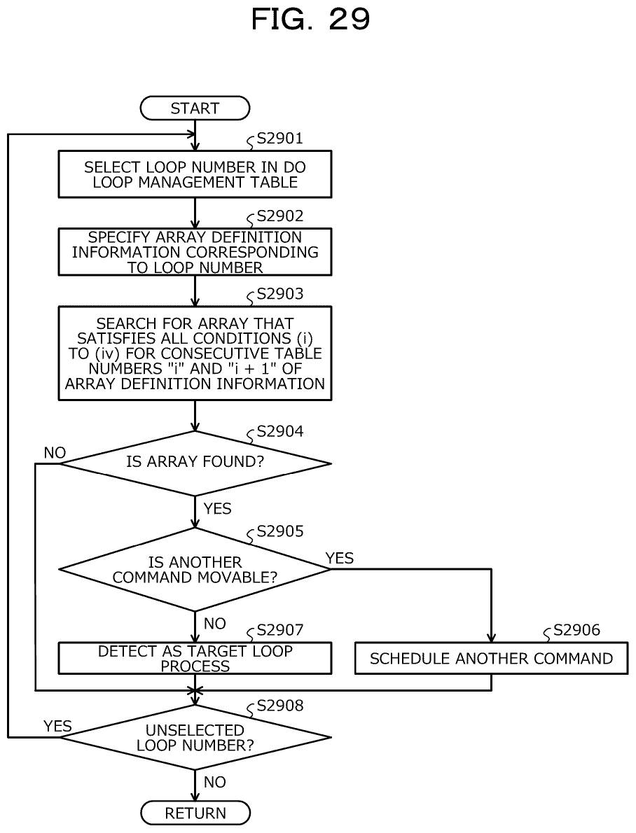

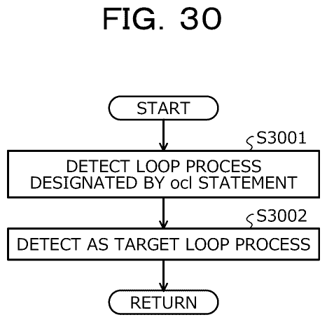

A specific process procedure of the target loop detection process will be described below with reference to FIGS. 29 and 30.

Next, the information processing apparatus 101 executes a loop configuration change process on the detected target loop process (step S2802). The loop configuration change process is a process of changing the target loop process to three loop configurations (initial loop, kernel loop, and end loop) that are logically equal.

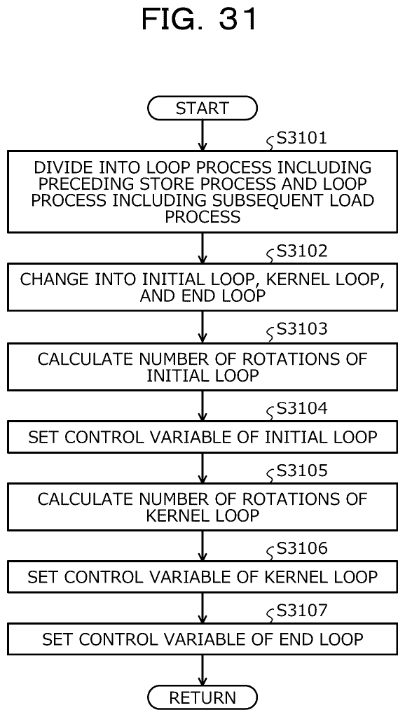

A specific process procedure of the loop configuration change process will be described below with reference to FIG. 31.

The information processing apparatus 101 generates a machine language program corresponding to the target program after the loop configuration change (step S2803), and ends a series of processes according to the present flowchart. In step S2802, in a case where no change in any loop configuration in the target program is made, the machine language program corresponding to the target program is generated. In a case where another command is scheduled in step S2906 illustrated in FIG. 29 to be described below, a machine language program corresponding to the target program in which the another command is scheduled is generated.

Therefore, the information processing apparatus 101 may improve performance of the target program.

Next, a specific process procedure of the target loop detection process in step S2801 illustrated in FIG. 28 will be described with reference to FIGS. 29 and 30. Here, as the target loop detection process, first and second target loop detection processes will be described as an example. Only any one of the first and second target loop detection processes may be executed, or both the first and second target loop detection processes may be executed.

First, a specific process procedure of the first target loop detection process will be described with reference to FIG. 29.

FIG. 29 is a flowchart illustrating an example of the specific process procedure of the first target loop detection process. In the flowchart in FIG. 29, first, the information processing apparatus 101 selects an unselected loop number that is not selected from among loop numbers in a DO loop management table of the target program (step S2901). The loop number to be selected may be, for example, a loop number of an innermost loop.

Next, the information processing apparatus 101 specifies array definition information corresponding to the selected loop number (step S2902). The information processing apparatus 101 searches for an array that satisfies all of the conditions (i) to (iv) for the consecutive table numbers “i” and “i+1” of the specified array definition information (step S2903).

$$ARRAY\_TBL ( i ) \cdot array = ARRAY\_TBL ( i + 1 ) \cdot array \qquad ( i )$$

$$\vert ARRAY\_TBL ( i ) \cdot one - dimensional subscript - ARRAY\_TBL ( i + 1 ) \cdot one - dimensional subscript \vert * element size < cachelinesize \qquad ( ii )$$

$$ARRAY\_TBL ( i ) \cdot definition = 1 ( set ) , and \\ ARRAY\_TBL ( i + 1 ) \cdot definition = 0 ( reference ) \qquad ( iii )$$

$$ARRAY\_TBL ( i ) \cdot statement identification number \leq ARRAY\_TBL ( i + 1 ) \cdot statement identification number \qquad ( iv )$$

Next, the information processing apparatus 101 determines whether or not an array satisfying all of the conditions (i) to (iv) is found (step S2904). In a case where the array is not found (No in step S2904), the information processing apparatus 101 proceeds to step S2908.

On the other hand, in a case where the array is found (Yes in step S2904), the information processing apparatus 101 determines whether or not another command may be moved between a preceding store command and a subsequent load command for accessing the found array (step S2905). The another command is, for example, an arithmetic command, a transcription command, or the like, which is a command without a dependency relationship in the same basic block as the preceding store command and the subsequent load command, and which takes the number of cycles equal to or higher than the number of cycles of SFI delay (or equal to or higher than a predetermined number of cycles).

In a case where the another command is movable (Yes in step S2905), the information processing apparatus 101 schedules the another command between the preceding store command and the subsequent load command (step S2906), and proceeds to step S2908.

On the other hand, in a case where the another command is not movable (No in step S2905), the information processing apparatus 101 detects a loop process (loop process of the selected loop number) including the preceding store command and the subsequent load command for accessing the found array as the target loop process (step S2907).

The information processing apparatus 101 determines whether or not there is an unselected loop number that is not selected among the loop numbers in the DO loop management table (step S2908). In a case where there is an unselected loop number (Yes in step S2908), the information processing apparatus 101 returns to step S2901.

On the other hand, in a case where there is no unselected loop number (No in step S2908), the information processing apparatus 101 returns to the step of calling the target loop detection process (first target loop detection process).

Therefore, the information processing apparatus 101 may automatically detect the loop process including the store command and the load command which cause SFI as the target loop process.

Next, a specific process procedure of the second target loop detection process will be described with reference to FIG. 30.

FIG. 30 is a flowchart illustrating an example of the specific process procedure of the second target loop detection process. In the flowchart in FIG. 30, first, the information processing apparatus 101 specifies a loop process including an array to be avoided from SFI, which is designated by an ocl statement, from a target program (step S3001).

The information processing apparatus 101 detects the specified loop process as a target loop process (step S3002), and returns to the step of calling the target loop detection process (second target loop detection process).

Therefore, the information processing apparatus 101 may detect the loop process, which is designated by a user and which is a high-cost loop, as the target loop process.

In step S3002, the information processing apparatus 101 may determine whether or not the specified loop process includes an array satisfying all of the conditions (i) to (iv) described above, with reference to a DO loop management table and array definition information, for example. In a case where the array satisfying all of the conditions (i) to (iv) described above is included, the information processing apparatus 101 may detect the specified loop process as the target loop process.

Therefore, the information processing apparatus 101 may detect the loop process, which is designated by the user and which is expected to have performance improvement by SFI suppression, as the target loop process.

In step S3002, for example, in a case where the information processing apparatus 101 determines that the specified loop process is a high-cost loop by referring to the profile information or the event information at a time of execution for the specified loop process, the specified loop process may be detected as the target loop process. In step S3001, the information processing apparatus 101 may specify the loop process determined to be a high-cost loop based on, for example, the profile information or the event information at the time of execution.

Here, the target loop process is designated by the ocl statement, but the present embodiment is not limited thereto. For example, the loop process to be excluded from the target loop process may be designated by the ocl statement. In this case, the information processing apparatus 101 may detect the target loop process from the target program by excluding the loop process designated by the ocl statement.

Next, a specific process procedure of the loop configuration change process in step S2802 illustrated in FIG. 28 will be described with reference to FIG. 31. In a case where the target loop process is not detected in the target loop detection process in step S2801 illustrated in FIG. 28, the information processing apparatus 101 skips the loop configuration change process in step S2802.

FIG. 31 is a flowchart illustrating an example of the specific process procedure of the loop configuration change process. In the flowchart in FIG. 31, first, the information processing apparatus 101 divides the detected target loop process into a loop process (LS) including the preceding store process (PS) and a loop process (LL) including the subsequent load process (PL) (step S3101).

The number of rotations of the two divided loop processes (LS and LL) are the same as the number of rotations before the division. An execution order of the loop process (LS) and the loop process (LL) is “LS→LL”.

Next, the information processing apparatus 101 changes the divided loop process (LS) and the loop process (LL) into an initial loop, a kernel loop, and an end loop (step S3102). The information processing apparatus 101 calculates the number of rotations D (the number of loop rotations) of the initial loop (step S3103). The number of rotations D is calculated by using, for example, Expression (1) described above.

Next, the information processing apparatus 101 sets a control variable (initial value: is, end value: ie, and increment value: id) of the initial loop based on the calculated number of rotations D (step S3104). The information processing apparatus 101 calculates the number of rotations (n−D) of the kernel loop based on the calculated number of rotations D (step S3105).

Next, the information processing apparatus 101 sets a control variable (initial value: ks, end value: ke, and increment value: kd) of the kernel loop based on the calculated number of rotations (n−D) (step S3106). In this case, the information processing apparatus 101 changes the subscript (i) and the variable i of the array in the store process (PS) such that the store process (PS) is not executed twice on the same array, in the kernel loop.

The information processing apparatus 101 sets a control variable (initial value: es, end value: ee, increment value: ed) of the end loop by setting the number of rotations of the end loop to the same number of rotations D as the number of rotations of the initial loop (step S3107), and returns to the step of calling the loop configuration change process.

Therefore, the information processing apparatus 101 may change the target loop process into the three loop configurations (initial loop, kernel loop, and end loop) that are logically equal.

As described above, with the information processing apparatus 101 according to the embodiment, a target loop process including a preceding store command and a subsequent load command may be detected from a target program, and the detected target loop process may be changed into an initial loop (first loop process), a kernel loop (second loop process), and an end loop (third loop process). The initial loop is a loop process of executing the preceding store command in advance for the number of rotations D (the first number of times) among the number of loop rotations n (the number of iteration times) of the target loop process such that access address of the preceding store command and the access address of the subsequent load command are not in the same cache line. The kernel loop is a loop process of executing the preceding store command and the subsequent load command for the number of times (n−D) by subtracting the number of rotations D from the number of loop rotations n of the target loop process after the initial loop. The end loop is a loop process of executing the subsequent load command for the number of rotations D after the kernel loop. A cache line is an example of the same access unit from a processor (for example, the CPU 401) to a memory (for example, the memory 402).

Therefore, the information processing apparatus 101 may avoid a decrease in performance caused by SFI occurring between the preceding store command and the subsequent load command in the target loop process for the target program, and may improve performance of the target program.

With the information processing apparatus 101, the number of rotations D may be calculated based on a difference in access address between the preceding store command and the subsequent load command, an element size, and a cache line size. The element size is an example of a data size of a process unit of the preceding store command and the subsequent load command. The cache line size is an example of a data size of an access unit from the processor to the memory.

Therefore, the information processing apparatus 101 may provide a difference in access address such that the preceding store command and the subsequent load command do not access the nearby address having the same address or the same cache line. For example, according to the information processing apparatus 101, the number of rotations D may be calculated by dividing a value obtained by subtracting a size corresponding to the difference in access address between the preceding store command and the subsequent load command from the cache line size by the element size. Therefore, the information processing apparatus 101 may adjust the number of rotations D such that the preceding store command is executed in advance by one cache line size in the initial loop. In the kernel loop, the information processing apparatus 101 may avoid a decrease in performance without occurrence of SFI since the access addresses of the preceding store command and the subsequent load command are separated by one cache line size. The information processing apparatus 101 may suppress an increase in a deviation in the processing amount between loops (for example, between the initial loop and the end loop), by executing the preceding store command in advance in the initial loop by one cache line size.

With the information processing apparatus 101, it is possible to detect a loop process, which includes the preceding store command and the subsequent load command for the same array and in which a value obtained by multiplying a difference in access address between the preceding store command and the subsequent load command by the element size is less than the cache line size, as the target loop process.

Therefore, the information processing apparatus 101 may automatically detect a loop location (high-cost loop) including the preceding store command and the subsequent load command for an array as an SFI target.

With the information processing apparatus 101, a loop process designated by an instruction statement in a target program may be detected as the target loop process. For example, in a case of FORTRAN, the instruction statement is an ocl statement. In a case of C language, the instruction statement is a text string starting with “#pragma”.

Therefore, the information processing apparatus 101 may detect a loop location that is to be a high-cost loop designated in advance by a user, as the target loop process.

With the information processing apparatus 101, the control variables of the initial loop (initial value: is, end value: ie, and increment value: id), the control variables of the kernel loop (initial value: ks, end value: ke, and increment value: kd), and the control variables of the end loop (initial value: es, end value: ee, increment value: ed) may be set based on the number of rotations D.

Therefore, the information processing apparatus 101 may adjust the control variable of each loop such that the number of times of execution of the preceding store command and the number of times of execution of the subsequent load command are the same before and after the loop configuration is changed.

With the information processing apparatus 101, the target loop process may be detected from the target program based on execution information (for example, profile information and event information) obtained by executing the target program.

Therefore, the information processing apparatus 101 may detect, as the target loop process, a loop location that is a high-cost loop and is determined to be avoided from SFI from the profile information, the event information, and the like obtained at the time of execution.

With the information processing apparatus 101, it is possible to generate a machine language program corresponding to the target program after the change.

Therefore, the information processing apparatus 101 may translate the optimized target program into the machine language program.

From these facts, with the present compiling program and the present compiling method, it is possible to avoid interlock by SFI and significantly improve performance of a program. For example, by applying the present compiling method to a program including a high-cost loop, a process speedup by approximately 8 to 9 times is realized. With the present compiling program and the present compiling method, since a delay due to internal cycle occurrence is no longer present, operation efficiency of a processor may be improved and power consumption may be reduced. For example, by applying the present compiling method to an environment simulation, a disaster simulation, or the like, a significant reduction in power consumption may be expected.

The compiling method described in the present embodiment may be realized by executing a program prepared in advance on a computer such as a personal computer or a workstation. The present compiling program is recorded on a computer-readable recording medium such as a hard disk, a flexible disk, the CD-ROM, the DVD, or the USB memory and is executed as a result of being read from the recording medium by a computer. The present compiling program may also be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a compiling program causing a computer to execute a process comprising:
detecting a target loop process that includes a store command and a load command subsequent to the store command, from a program as an optimization target; and
changing the detected target loop process into a first loop process of executing the store command in advance for a first number of times among the number of iteration times of the target loop process, a second loop process of executing the store command and the load command for a second number of times obtained by subtracting the first number of times from the number of iteration times after the first loop process, and a third loop process of executing the load command for the first number of times after the second loop process such that an access address of the store command and an access address of the load command are not in the same access unit from a processor to a memory.

2. The non-transitory computer-readable recording medium according to claim 1, the compiling program causing the computer to execute a process comprising:
calculating the first number of times, based on a difference in access address between the store command and the load command, a data size of a process unit of the store command and the load command, and a data size of the access unit.

3. The non-transitory computer-readable recording medium according to claim 1,
wherein in the detecting,
a loop process which includes a store command and a load command subsequent to the store command for the same variable, and in which a value obtained by multiplying a difference in access address of the store command and the load command by a data size of a process unit of the store command and the load command is less than a data size of the access unit is detected as the target loop process.

4. The non-transitory computer-readable recording medium according to claim 1,
wherein in the detecting,
a loop process designated by an instruction statement in the program is detected as the target loop process.

5. The non-transitory computer-readable recording medium according to claim 1,
wherein the access unit is a cache line.

6. The non-transitory computer-readable recording medium according to claim 2,
wherein in the calculating,
the first number of times is calculated by dividing a value obtained by subtracting a size that corresponds to the difference in access address from the data size of the access unit by the data size of the process unit.

7. The non-transitory computer-readable recording medium according to claim 2,
wherein in the changing,
a control variable of the first loop process, a control variable of the second loop process, and a control variable of the third loop process are set based on the first number of times.

8. The non-transitory computer-readable recording medium according to claim 1,
wherein in the detecting,
the target loop process is detected from the program, based on execution information obtained by executing the program.

9. The non-transitory computer-readable recording medium according to claim 1, the compiling program causing the computer to execute a process comprising:
generating a machine language program that corresponds to the changed program after the target loop process is changed into the first loop process, the second loop process, and the third loop process.

10. A compiling method causing a computer to execute a process comprising:
detecting a target loop process that includes a store command and a load command subsequent to the store command, from a program as an optimization target; and
changing the detected target loop process into a first loop process of executing the store command in advance for a first number of times among the number of iteration times of the target loop process, a second loop process of executing the store command and the load command for a second number of times obtained by subtracting the first number of times from the number of iteration times after the first loop process, and a third loop process of executing the load command for the first number of times after the second loop process such that an access address of the store command and an access address of the load command are not in the same access unit from a processor to a memory.
